(19) United States
(12) Patent Application Publication
(10) Pub. No.: US 2014/0331013 A1
(43) Pub. Date: Nov. 6, 2014

(54) ARITHMETIC PROCESSING APPARATUS AND CONTROL METHOD OF ARITHMETIC PROCESSING APPARATUS

(71) Applicant: FUJITSU LIMITED, Kawasaki-shi (JP)

(72) Inventors: Hiroyuki Ishii, Kawasaki (JP); Hiroyuki Kojima, kawasaki (JP); Hideki SAKATA, Kawasaki (JP)

(21) Appl. No.: 14/297,991

(22) Filed: Jun. 6, 2014

Related U.S. Application Data
(63) Continuation of application No. PCT/JP2011/078287, filed on Dec. 7, 2011.

(51) Int. Cl. G06F 9/30; G06F 12/08

(52) U.S. Cl. CPC G06F 9/30047; G06F 12/0806; G06F 2212/62
USPC 711/145

(57) ABSTRACT

An arithmetic processing apparatus according to one embodiment of the present invention includes: a plurality of arithmetic processing units configured to perform arithmetic operations to output access requests; a cache memory to retain data undergoing the arithmetic processes of the arithmetic processing units in cache blocks; a retaining unit configured to retain a control target address specifying a control target cache block and control target identifying information specifying an arithmetic processing unit of a control target access requester; and a control unit configured to control an access request for the cache block specified by the control target address and the control target identifying information on the basis of an access target address contained in an access request issued by any one of the arithmetic processing units and requester identifying information specifying the arithmetic processing unit having issued the access request.

### CROSS-REFERENCE TO RELATED APPLICATION

This application is a continuation application of International Application PCT/JP2011/078287 filed on Dec. 7, 2011 and designated the U.S., the entire contents of which are incorporated herein by reference.

### FIELD

The present invention relates to an arithmetic processing apparatus and a control method of an arithmetic processing apparatus.

### BACKGROUND

A cache memory has hitherto been used for compensating a difference between an execution speed of a processor core and an access speed to amain storage device. Most of the cache memories are hierarchized at 2 or more levels in terms of a tradeoff relationship between the access speed and a memory capacity. The hierarchized cache memories are called a first level (L1) cache memory, a second level (L2) cache memory, etc. in the sequence from the closest to the processor core. It is to be noted that the processor core will hereinafter be also simply referred to as the “core”. The main storage device will hereinafter be also simply referred to as a “memory” or a “main memory”. The cache memory will hereinafter be also simply termed a “cache”.

Data in the main memory are associated with the cache memories on a block-by-block basis. A set associative scheme is known as a method of associating blocks of the main memories with the blocks of the cache memories. It is to be noted that the blocks of the main memories are particularly referred to as the “memory blocks” for distinguishing the blocks of the main memories from the blocks of the cache memories in the following discussion. Further, the blocks of the cache memories are referred to as “cache blocks”, “lines” or “cache lines”.

The set associative scheme is defined as the method of dividing the main memories and the cache memories into some number of sets and associating the main memory with the cache memories within each set. Note that the “set” is also called a column. The set associative scheme specifies the number of the cache blocks of the cache memories, which are containable within each set. The number of the containable cache blocks is called a row count, a level count or a way count.

In the set associative scheme, the cache block is identified by an index and way information. To be specific, the set containing the cache blocks is identified by the index. Further, a relevant cache block in the cache blocks contained within the set is identified by the way information. The way information is, e.g., a way number used for identifying the relevant cache block.

Addresses of allocation target memory blocks are used for allocating the memory blocks and the cache blocks. In the set associative scheme, the allocation target memory block is allocated to any one of the cache blocks contained in the set specified by the index coincident with a part of the address of the memory block. Namely, the index within the cache memory is designated by a part of the address. A part of the address, which is used for designating the index within the cache memory, is also called a set address.

Note that the address used for the allocation may be anyone of a physical address (real address) and a logical address (virtual address). These addresses are expressed by bits. In the main memory, the memory blocks contained in the same set are memory blocks having the same set address.

The main memory generally has a larger capacity than the cache memory has. Therefore, the number of the memory blocks of the main memory, which are contained in the set, is larger than the number of the cache blocks of the cache memory, which are contained in the set. Accordingly, all the memory blocks of the main memory cannot be allocated to the cache blocks of the cache memory. Namely, the memory blocks of the main memory, which are contained in each set, can be divided into the memory blocks allocated to the cache blocks of the cache memory that are contained in each set and the unallocated memory blocks.

Herein, for example, such a situation is considered that the data is acquired from the cache block allocated with the memory block in place of the memory block associated with the address designated by the processor core. In this case, within the cache memory, there is retrieved the cache block allocated with the memory block associated with the address designated by the processor core.

If the cache block is hit in this retrieval, the processor core can acquire the designated data from the hit cache block within the cache memory. On the other hand, if the cache block is not hit in this retrieval, the processor core cannot acquire the designated data from the cache memory. In this case, the processor core acquires the designated data from the main memory. Such a situation is also called a cache mishit.

Note that the index and a cache tag are used for retrieving the cache block allocated with the memory block associated with the address designated by the processor core. The index indicates, as described above, the set containing the relevant cache block. Further, the cache tag is used for retrieving the cache block associated with the memory block within each set.

The cache tag is provided per cache block. On the occasion of allocating the memory block to the cache block, a part of the address of the memory block is stored in the cache tag associated with the cache block. A part of the address, which is stored in the cache tag, is different from the set address. Specifically, the cache tag stores an address having a proper bit length, which is acquired from a part given by subtracting the set address from the address of the memory block. Note that the address stored in the cache tag will hereinafter be termed a “tag address”.

The cache block allocated with the memory block associated with the address designated by the processor core, is retrieved by employing the index and the cache tag described as such.

For example, to start with, the set having a possibility of containing the cache block allocated with the memory block associated with the address designated by the processor core, is retrieved from the cache memory. Concretely, the index coincident with the relevant partial address, corresponding to the set address, of the address designated by the processor core, is retrieved from the cache memory. The set indicated by the index retrieved at this time is the set having the possibility of containing the cache block allocated with the memory block associated with the address designated by the processor core.

Then, the cache block allocated with the memory block associated with the address designated by the processor core is retrieved from the cache block contained in the set indicated by the retrieved index. To be specific, the cache tag storing a partial address, corresponding to a tag address, of the address designated by the processor core, is retrieved from within the cache tags associated with the respective cache blocks contained in the retrieved set. The cache block associated with the cache tag retrieved at this time is the cache block allocated with the memory block associated with the address designated by the processor core.

Note that if not retrieving the cache tag storing the partial address, corresponding to the tag address, of the address designated by the processor core in the retrieval process, this is the cache mishit. In this case, the cache block allocated with the memory block associated with the address designated by the processor core does not exist within the cache memory. Therefore, the data designated by the processor core is acquired from the main memory.

The cache block allocated with the memory block associated with the address designated by the processor core is thus retrieved. With this operation, the data stored in the memory block is stored also in the cache memory, in which case this data is acquired from the cache memory. While on the other hand, the data stored in the memory block is not stored in the cache memory, in which case this data is acquired from the memory block.

Note that in addition to the set associative scheme, methods such as a direct mapping scheme and a full associative scheme are known as the methods of associating the blocks of the cache memories with the blocks of the main memories. The direct mapping scheme is defined as a method of determining the blocks of the cache memories that are associated with the blocks of the main memories by use of addresses of the blocks of the main memories. The direct mapping scheme corresponds to the associative scheme in such a case that the way count is “1” in the set associative scheme. Further, the full associative scheme is a method of associating arbitrary blocks of the cache memories with arbitrary blocks of the main memories.

On the other hand, in recent years, a multi-core processor system including a plurality of processor cores has become a mainstream in terms of improving performance and reducing power consumption per chip. In the multi-core processor systems, e.g., there is known a multi-core processor system configured such that each of the processor cores includes L1 cache memories, and a L2 cache memory is shared among the plural processor cores.

At this time, the L2 cache memory is equipped with a mechanism for keeping cache coherency defined as a matching property between the cache memories, the mechanism being provided between the L2 cache memory and the L1 cache memories held by the plurality of processor cores that share the L2 cache memory with each other. For keeping the cache coherency, when a certain processor core requests the L2 cache memory for the data, it is checked whether or not the requested data is stored in the L1 cache memory held by each processor core.

A method by which the L2 cache memory snoops the L1 cache memories of all the processor cores whenever making the data request, is known as a method of examining whether or not the data requested from a certain processor core is stored in each L1 cache memory. In this method, however, it follows that latency till giving a response to the data request gets elongated to such a degree as to take a machine cycle until a query result is returned from the L1 cache memory.

Patent document 1 discloses a method of improving this latency. Patent document 1 discloses the method of eliminating the process of snooping the L1 cache memories by storing copies of the cache tags of the L1 cache memories into a cache tag of the L2 cache memory.

When the copies of the cache tags of the L1 cache memories are stored in the cache tag of the L2 cache memory, the L2 cache memory can refer to statuses of the L1 cache memories in the cache tag of itself. Therefore, the L2 cache memory can examine whether or not the data requested from a certain processor core is stored in each L1 cache memory without snooping the L1 cache memories. Patent document 1 discloses the method of improving the latency by the method described as such. Note that the cache tags of the L1 cache memories will hereinafter be called L1 tags. Further, the cache tag of the L2 cache memory is called an L2 tag.

However, as a difference between a capacity of the L2 cache memory and a capacity of the L1 cache memories becomes larger, less of the data stored in the L2 cache memory are stored in the L1 cache memories. For this reason, if a field to store the copy of the L1 tag is provided in the L2 tag, the field to store the L1 tag copy in the L2 tag results in a futile field that is not substantially used. This status is not preferable in terms of a physical quantity and the power consumption, and hence the improvement thereof is demanded.

Patent documents 2 and 3 disclose methods of improving this futile field. Patent documents 2 and 3 disclose methods of storing, in place of the L1 tag copies, information indicating a shared status of the lines in the respective L1 cache memories in the L2 tag and storing the L1 tag copies in a field different from that of the L2 tag.

### DOCUMENTS OF PRIOR ARTS

### Patent Document

[Patent document 1] Japanese Laid-Open Patent Publication No. 2006-40175
[Patent document 2] Japanese Patent No. 4297968
[Patent document 3] Japanese Laid-Open Patent Publication No. 2011-65574

### SUMMARY

An arithmetic processing apparatus according to one aspect of the present invention includes: a plurality of arithmetic processing units to respectively perform arithmetic operations and to output access requests; a cache memory to retain data undergoing the arithmetic processes of the plurality of arithmetic processing units in cache blocks; a retaining unit to a control target address specifying a control target cache block and control target identifying information specifying the arithmetic processing unit of a control target access requester; and a control unit to control the access request for the cache block specified by the control target address and the control target identifying information on the basis of an access target address contained in the access request issued by any one of the plurality of arithmetic processing units and requester identifying information specifying the arithmetic unit having issued the access request.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF THE DRAWINGS

FIG. 1 illustrates a conventional multi-core processor system;

FIG. 2 illustrates an operational example of invalidating processes executed in a batch;

FIG. 3 illustrates an entry of an L1 tag copy in which read is assured on the occasion of the invalidating processes executed in a batch;

FIG. 4 illustrates conventional retry control;

FIG. 5 illustrates an update process of the L1 tag copy in the batch invalidation;

FIG. 6 illustrates a logical circuit related to a conventional retry determination;

FIG. 7A illustrates an operation in the case of updating the L1 tag copy when issuing an order;

FIG. 7B illustrates an operation in the case of updating the L1 tag copy when issuing the order;

FIG. 8 illustrates a status transition related to an update of L1 shared information;

FIG. 9A illustrates an operation in the case of updating the L1 tag copy when making an order response;

FIG. 9B illustrates an operation in the case of updating the L1 tag copy when making the order response;

FIG. 10 illustrates an operation in the case of occurrence of access requests related to a plurality of L1 REPLACEs for the same line in a conventional method;

FIG. 11 illustrates an apparatus according to an embodiment;

FIG. 12 illustrates a data format of the cache tag according to the embodiment;

FIG. 13 illustrates a control block according to the embodiment;

FIG. 14A illustrates an operation of an L2 cache according to the embodiment;

FIG. 14B illustrates the operation of the L2 cache according to the embodiment;

FIG. 14C illustrates the operation of the L2 cache according to the embodiment;

FIG. 14D illustrates the operation of the L2 cache according to the embodiment;

FIG. 14E illustrates the operation of the L2 cache according to the embodiment;

FIG. 14F illustrates the operation of the L2 cache according to the embodiment;

FIG. 15 illustrates the case of the occurrence of the access requests related to four L1 REPLACEs at the same timing;

FIG. 16 illustrates a problem that can arise due to a reading sequence of the L1 tag copies;

FIG. 17 illustrates an operation for solving the problem illustrated in FIG. 16 according to the embodiment;

FIG. 18 illustrates circuits of an L2 cache control unit in the embodiment;

FIG. 19 is a flowchart illustrating an operational example of the L2 cache control unit in the embodiment;

FIG. 20 illustrates a circuit for detecting that a target order is a final determination target in the embodiment;

FIG. 21 illustrates an operation of locking an L1 REPLACE target address in the embodiment;

FIG. 22 illustrates an operation of retrying the request for the address kept locking in the embodiment;

FIG. 23 illustrates a retry determination circuit in the embodiment;

FIG. 24 illustrates an operation of a final response detecting circuit in the embodiment; and

FIG. 25 illustrates the final response detecting circuit in the embodiment.

### DESCRIPTION OF EMBODIMENTS

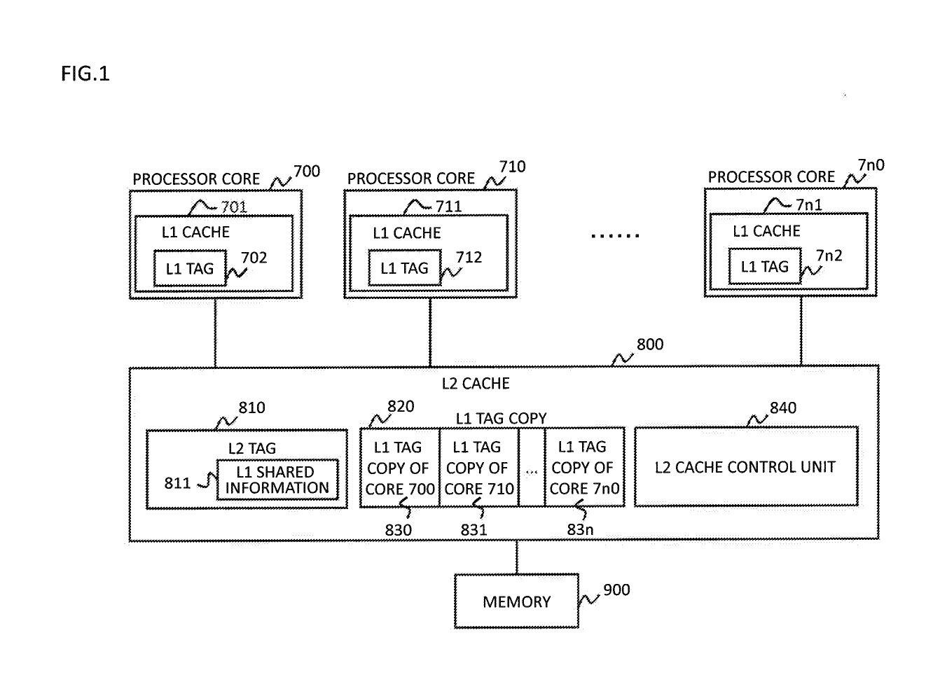

FIG. 1 illustrates an example of how first level caches (abbreviated to L1 caches) are connected to a second level cache (abbreviated to an L2 cache or referred to as a secondary cache) in a multi-core processor. A connection example depicted in FIG. 1 is that cores (700, 710, . . . , 7n0) include L1 caches (701, 711, . . . , 7n1), respectively. Note that “n” represents a natural number.

Then, an L2 cache 800 is shared among the cores (700, 710, . . . , 7n0). In the connection example illustrated in FIG. 1, the L2 cache 800 exists between a series of cores (700, 710, . . . , 7n0) and a memory 900.

Further, a field of an L2 tag 810 contains a sub-field for storing L1 shared information 811 indicating shared statuses of the lines among the respective L1 caches (701, 711, . . . , 7n1).

Furthermore, the L2 cache 800 includes a field, provided separately from the field of the L2 tag 810, for storing L1 tag copies 820 as copies of the L1 tags. In FIG. 1, an L1 tag copy 830 is a copy of an L1 tag 702 defined as an L1 cache tag of the core 700. An L1 tag copy 831 is a copy of an L1 tag 712 as the L1 cache tag of the core 710. An L1 tag copy 83n is a copy of an L1 tag 7n2 as the L1 cache tag of the core 7n0. It is to be noted that the set-associative scheme is adopted as a data storage structure for the respective L1 caches (701, 711, . . . , 7n1) and the L2 cache 800.

The L2 cache 800 executes a process related to access requests in response to these access requests given from the cores (700, 710, . . . , 7n0). The L2 cache 800 is equipped with one or more pipelines and is thereby enabled to execute parallel processing in response to the access requests given from the cores (700, 710, . . . , 7n0). It is to be noted that the “access request” will hereinafter be also referred to simply as “request”.

Such a case may arise that a plurality of access requests is simultaneously issued to a certain single cache line in the thus-structured L2 cache 800. A process given by way of one example is a process of invalidating in a batch the cache lines of the L1 caches (701, 711, . . . , 7n1), which correspond to this certain single cache line. The batch invalidating process is a process for invalidating the entire cache blocks of the L1 caches, which correspond to the cache lines of the L2 cache 800. For example, the batch invalidating process is executed for keeping cache coherency when an update occurs in any one of the cache blocks of the L1 caches.

In this case, according to, e.g., Patent document 2, the access requests for invalidating the cache lines of the L1 caches (701, 711, . . . , 7n1) are broadcasted to all of the cores (700, 710, . . . , 7n0). Further, according to, e.g., Patent document 3, the access requests for selectively invalidating the cache lines are issued to the cores having the relevant cache lines. Through these processes, the cache lines of the L1 caches (701, 711, . . . , 7n1), which correspond to the cache lines of the L2 cache 800, are invalidated.

Every process works to invalidate all of the cache blocks of the L1 caches, which correspond to the cache lines of the L2 cache 800. Therefore, after this process, L1 shared information 811 within an L2 tag 810 associated with the invalidation-related cache lines of the L2 cache 800 is updated to a status “INV”. Note that the status “INV” represents a status (invalid status) in which the corresponding cache blocks are invalid. Namely, the status “INV” indicates that none of the corresponding cache blocks exist in a valid status in all of the L1 caches (701, 711, . . . , 7n1).

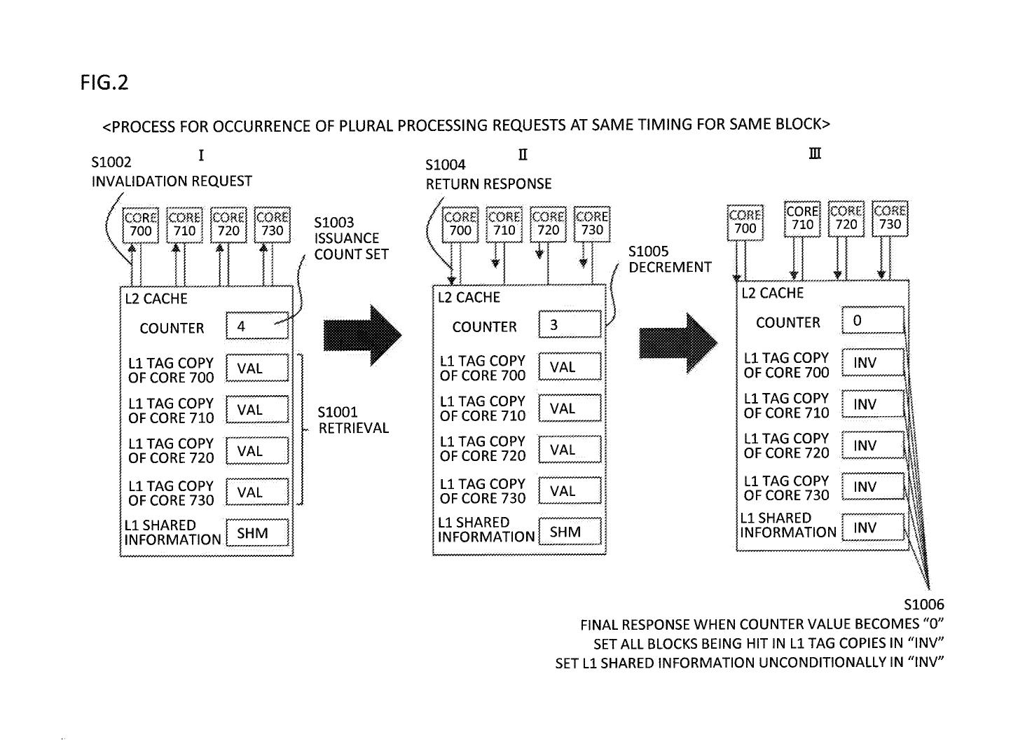

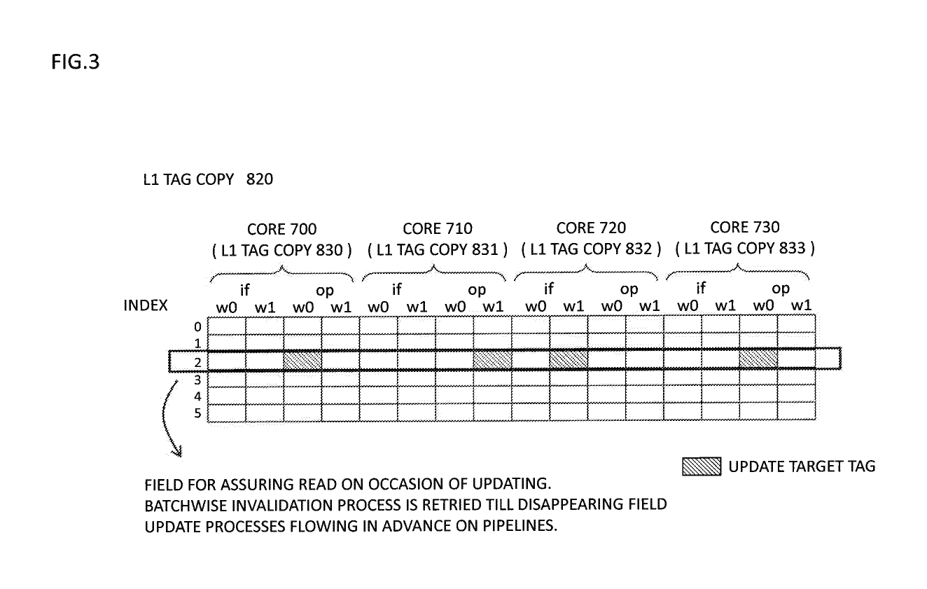

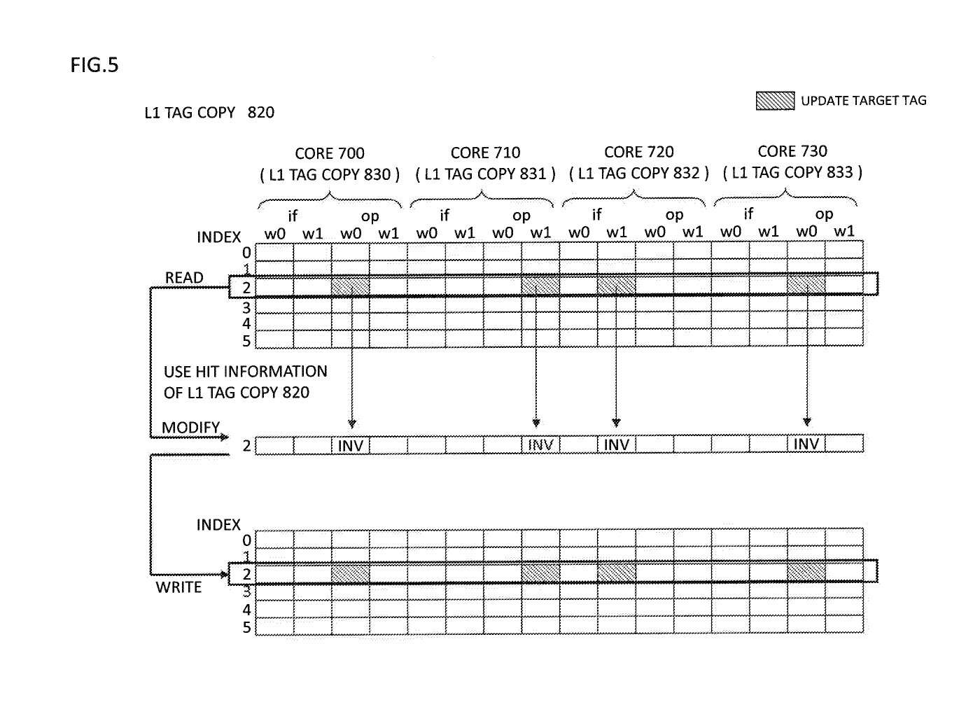

This process of invalidating the cache blocks of the L1 caches is executed in a batch. FIG. 2 illustrates an operational example of how the invalidating process is executed in a batch. The invalidating process is executed in a batch in a manner that follows. Incidentally, “step” is abbreviated to “S” in FIG. 2. The same abbreviation is applied to other drawings throughout. Further, FIG. 2 depicts an example that a core count (n+1) is “4”. Note that FIGS. 3 and 5 given later on illustrate likewise the examples in which the core count (n+1) is “4”.

To start with, an L2 cache control unit 840 retrieves the cache blocks of the L1 caches by use of an L1 tag copy 820, which correspond to the invalidating target cache blocks of the L2 cache 800 (S1001). Note that a status “VAL” described in each L1 tag copy illustrated in FIG. 2 indicates a status (valid status) that data are retained in a valid status in the cache block associated with each L1 tag copy.

Next, the L2 cache control unit 840 issues cache block invalidating requests in a batch to the cores (L1 caches) having the invalidating target cache blocks (S1002). Together with this issuance, the L2 cache control unit 840 sets an issuance count of the invalidation access requests issued to the L1 caches in a counter on the basis of a retrieval result of the L1 tag copy 820 (S1003). The issuance count to be set is a number of the cache lines of the L1 caches (701, 711, . . . , 7n1), the cache lines being retrieved by use of the L1 tag copy 820. The counter receiving the setting of the issuance count described above is prepared in, e.g., the L2 cache 800.

Then, each core executes the process of invaliding the cache blocks in response to the invalidating request. Subsequently, upon completing the invalidating process, the core sends a response of completion back to the L2 cache 800 (S1004).

The L2 cache control unit 840, each time the response of the completion of the invalidating process is sent back from the core, decrements the count set in the counter by “1” (S1005). The decrement being thus done, when the L2 cache control unit 840 decrements the count set in the counter according to a response of final completion of the invalidating process being finally completed (which will hereinafter be also referred to as “final completion response”) in the completion responses to a plurality of access requests, it follows that the count set in the counter becomes “0”. The L2 cache control unit 840 determines based on this counter value whether or not the completion response given from the core is the final completion response with respect to the same cache blocks in the L2 cache 800.

The L2 cache control unit 840, when determining that the completion response given from the core is the final completion response, updates data indicative of the statuses of the cache blocks contained in the L1 tag copies that correspond to the cache blocks having undergone the invalidating process into the status “INV”. Further, the L2 cache control unit 840 updates, into the status “INV”, the L1 shared information 811 existing within the L2 tag 810 associated with the invalidating target cache blocks of the L2 cache 800 (S1006). Thus, the cache blocks of the L1 caches, which correspond to the cache lines of the L2 cache 800, are invalidated in a batch.

Corresponding to this invalidating process executed in a batch, in S1006, the L1 tag copy 820 is updated in a batch. A “Read Modify Write” process, which will be described later on, executes updating the L1 tag copy 820 in processing on the pipelines. In the update process, for assuring a read of the L1 tag copy 820 in indices that indicate the cache blocks containing existence of update target cache blocks, a subsequent update process is re-executed (retried) if the preceding update process exists on the pipelines.

FIG. 3 illustrates entries in the L1 tag copy 820 of which the read is assured when the invalidating process is executed in a batch. An example illustrated in FIG. 3 is that invalidation processing target blocks are the cache blocks corresponding to the entries depicted by hatching in the cache blocks associated with an index “2”. In this case, when implementing the batch invalidation, as depicted in FIG. 3, the read of the cache blocks associated with the index “2” is assured. At this time, if the update process for any one of the cache blocks associated with the index “2” exists in advance on the pipelines, the batch update process of the L1 tag copy 820 is retried.

Note that symbols “w0” and “w1” in FIG. 3 represent a way number “0” and a way number “1”, respectively. A way is identified by this way number. Further, symbols “if” and “op” represent an instruction (IF) cache and an operand (OP) cache, respectively.

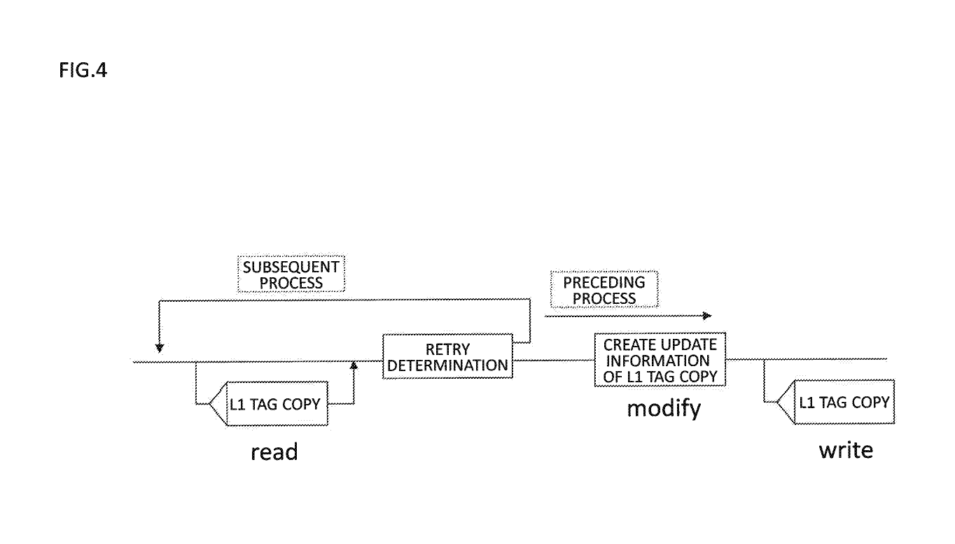

FIG. 4 illustrates how this retry process is controlled. Moreover, FIG. 5 depicts the update process that is executed based on the “Read Modify Write” process.

As illustrated in FIG. 4, at first, update processing target data stored in the entries of the L1 tag copy 820 are read (Read). In the examples illustrated in FIGS. 3 and 5, the data stored in the entries associated with the index “2” are the update processing target data.

Next, it is determined whether the batch update process of the L1 tag copy 820 can be executed or not. For example, an assumption is that batch update processing targets of the L1 tag copy 820 are the entries depicted by hatching in the index “2” illustrated in FIGS. 3 and 5. In this case, the determination as to whether the batch update process of the L1 tag copy 820 is executable or not is made corresponding to whether or not the update process for any one of the entries associated with the index “2” exists as a preceding process rendered flowing onto the pipelines.

To be specific, when the preceding processes flowing on the pipelines contain the update process for any one of the cache blocks associated with the index “2”, it is determined that the update process of the L1 tag copy 820 cannot be executed. At this time, the batch update process (subsequent process) of the L1 tag copy 820 is retried. Whereas when the preceding processes flowing on the pipelines contain none of the update process for any cache blocks associated with the index “2”, it is determined that the update process of the L1 tag copy 820 can be executed. At this time, the batch update process of the L1 tag copy 820 is shifted to an execution stage.

Then, when the batch update process of the L1 tag copy 820 is shifted to the execution stage, the data related to the update target entries are modified on the pipelines, thereby generating data for updating the L1 tag copy 820 (Modify). In an example illustrated in FIG. 5, on the pipelines, the data representing the statuses of the cache blocks corresponding to the entries depicted by hatching are modified into the status “INV”.

Furthermore, as illustrated in FIGS. 4 and 5, the thus-generated data are written to the L1 tag copy 820 (Write), whereby the L1 tag copy 820 is updated in a batch. Thus, the L1 tag copy 820 is updated in a batch.

A control method illustrated in FIGS. 2 through 5 is that the L1 tag copy 820 is, after detecting the completion of the final response, invalidated in a batch. At this time, a retrieval result (hit information) of the L2 tag 810 is used for specifying the update target entry in the L1 tag copy 820 as the case may be. A reason why the retrieval through the L1 tag copy 820 involves using the retrieval result of the L2 tag 810 is that there are restraints in terms of implementation of a physical quantity, a delay, etc. of the L1 tag copy 820. In such a case, after retrieving through the L2 tag 810 and further the L1 tag copy 820, a retry determination of the batch update process is executed, and hence it follows that a delay occurs in timing for making the retry determination.

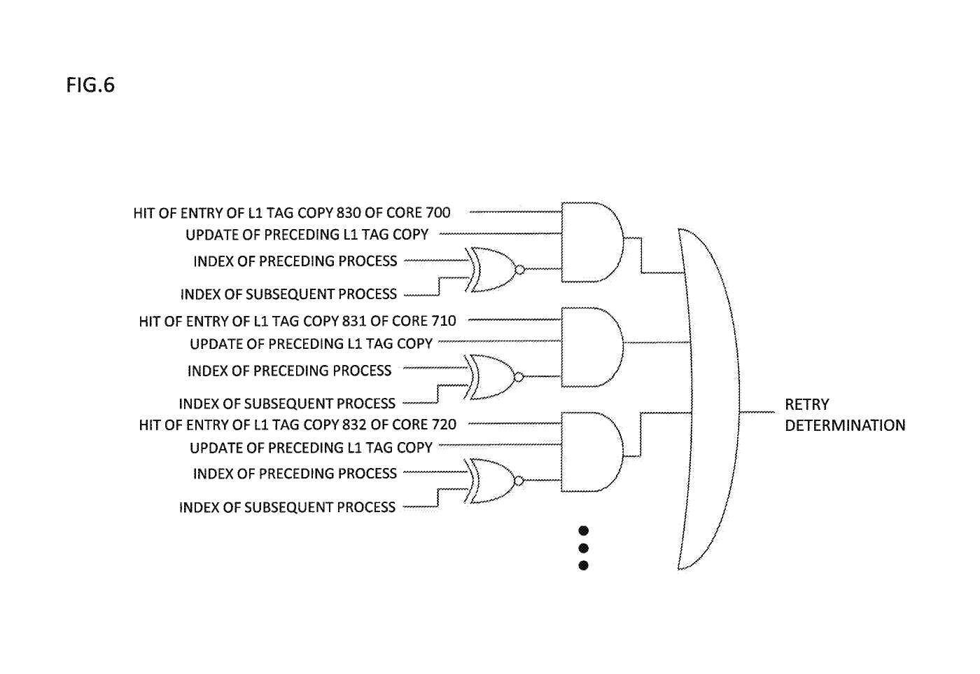

Moreover, logical sums of pieces of hit information of the L1 tag copy 820 corresponding to the core count are taken for the retry determination of the batch invalidating process described as such. FIG. 6 illustrates a logical circuit for the retry determination based on a conventional method. As illustrated in FIG. 6, the retry determination based on the conventional method generates the logical sums of the hit information of the L1 tag copy 820 corresponding to the core count, and hence a gate-delay problem arises as the cores increase in number.

On the other hand, such a case exists also other than in the batch invalidating process that the plurality of access requests occurs on a certain single line of the L2 cache 800 at the same timing. The case of the plural access requests occurring on the same line at the same timing is exemplified by a case in which the access requests based on “L1 REPLACE” individually occurring in each core are made at the same timing.

The L1 REPLACE is defined as a replacement process that occurs in the case of, e.g., a cache mishit in the L1 caches. If the data requested from the core is not cached in the L1 cache, this data is acquired from the L2 cache or the memory and then cached in the L1 cache. In the L1 cache, the data is cached in any one of the lines within the set specified by the index coincident with some portion of an address of this data.

On the occasion of thus writing the data in the L1 caches, in some cases, all of the lines within a write target set already have data cached therein, and have no empty space. Hereat, the data replacement process occurs on the lines specified based on a replacement algorithm such as an LRU (Least Recently Used) algorithm in order to write the data requested from the cores to the L1 caches. This replacement process is defined as the L1 REPLACE.

Note that in a terminology of the L1 REPLACE, the data written to a REPLACE target line will hereinafter be referred to as “REPLACE request data”, and an address associated with this data will hereinafter be referred to as a “REPLACE request address”, respectively. As described above, the REPLACE request data is the target data of the access request given from the core. Moreover, data to be replaced with the REPLACE request data on the basis of the L1 REPLACE is referred to as “REPLACE target data”, and an address associated with this data is referred to as a “REPLACE target address”, respectively.

The core, when executing the L1 REPLACE, requests the L2 cache 800 to acquire the REPLACE request data related to the L1 REPLACE. The L2 cache 800 retrieves the line for caching the REPLACE request data in response to this request. Then, the L2 cache 800 requests the core making the request for acquiring the REPLACE request data related to the L1 REPLACE to execute the L1 REPLACE together with the REPLACE request data acquired from the retrieved line. Note that the REPLACE request data, if not cached in the L2 cache 800, is acquired from the memory 900 on the basis of the REPLACE request address.

At this time, the L2 cache 800 executes updating the L1 tag copy 820 according to the L1 REPLACE carried out in the L1 cache. Specifically, the cache tag associated with the REPLACE request address is overwritten to the entry of the L1 tag copy 820, the entry storing the cache tag associated with the REPLACE target address.

Such a case exists that the L1 REPLACEs described above occur in the plurality of cores within a predetermined period. In this case, e.g., when the REPLACE target address is common between the plurality of occurred L1 REPLACEs, the plurality of access requests occurs within the predetermined period in the lines, associated with the common REPLACE target address, of the L2 cache 800.

Herein, the L1 tag copy 820 is updated based on the L1 REPLACE when issuing an order based on the access request of the L1 REPLACE or at timing when making a response to this order. Further, if the L1 tag copy 820 is individually updated based on the L1 REPLACE, unlike the example of the batch invalidation, the L1 shared information 811 related to the REPLACE target address is not necessarily updated into the status “INV”. The reason why so lies in a case where the REPLACE target data is cached in the L1 cache of the core other than the cores undergoing the occurrence of the L1 REPLACEs. Therefore, in this case, a shared status of the REPLACE target data is determined by referring to the L1 tag copy 820, thereby updating the L1 shared information 811.

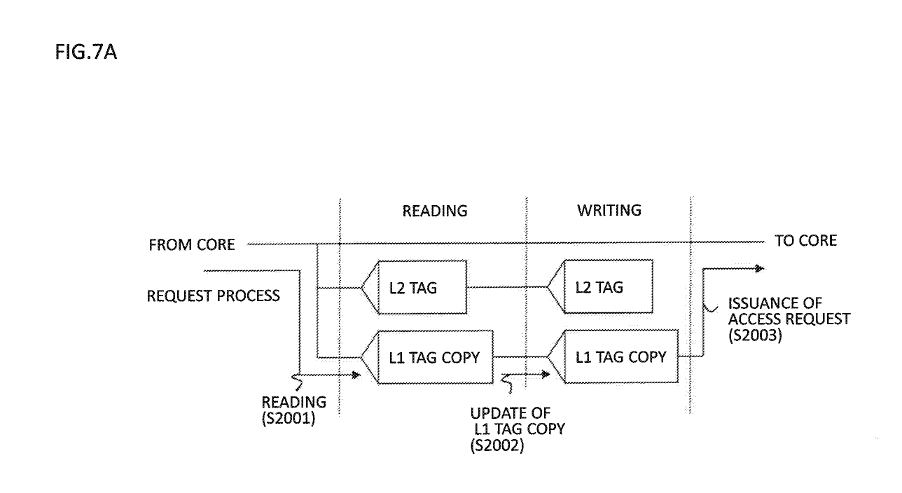

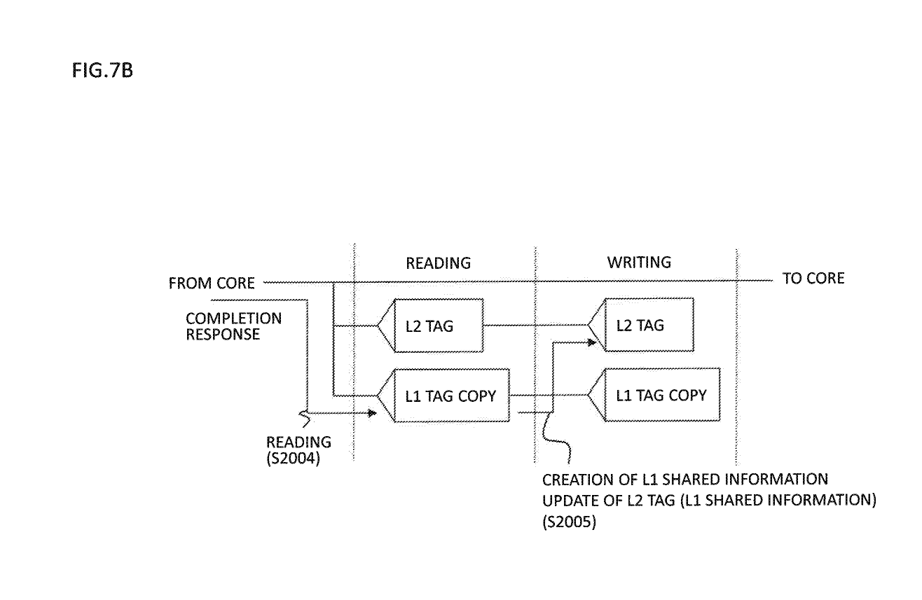

FIGS. 7A and 7B illustrate operational examples in the case of updating the L1 tag copy 820 when issuing the order. In this case, at the first onset, as depicted in FIG. 7A, in the L2 cache 800, the L2 cache control unit 840 retrieves the line that caches the REPLACE request data in response to the access request given from the core. Further, the L2 cache control unit 840 reads the entry, which stores the cache tag associated with the REPLACE target address, of the L1 tag copy 820 (S2001). Next, the L2 cache control unit 840 overwrites the cache tag associated with the REPLACE request address on the entry of the L1 tag copy of the core issuing the access request based on the L1 REPLACE in the readout entries (S2002). Then, the L2 cache 800 requests, based on the readout data, the core issuing the access request based on the L1 REPLACE to execute this L1 REPLACE (S2003).

Upon completing the processes related to the L1 REPLACE, as illustrated in FIG. 7B, the core issues, to the L2 cache 800, notification (completion response) indicating that the processes related to the L1 REPLACE are completed (S2004). In the L2 cache 800, the L2 cache control unit 840 retrieves the line of the L1 cache to cache the REPLACE target data through the L1 tag copy 820 in a way that corresponds to the completion response given from the core. Moreover, the L2 cache control unit 840 makes a determination about the shared status of the REPLACE target data on the basis of the retrieval result. Then, the L2 cache control unit 840 creates L1 shared information indicative of the shared status of the REPLACE target data on the basis of the determination result, and overwrites the created L1 shared information on the L1 shared information 811 that is associated with the REPLACE target address. Through this process, the L2 cache control unit 840 updates the L1 shared information 811 (S2005).

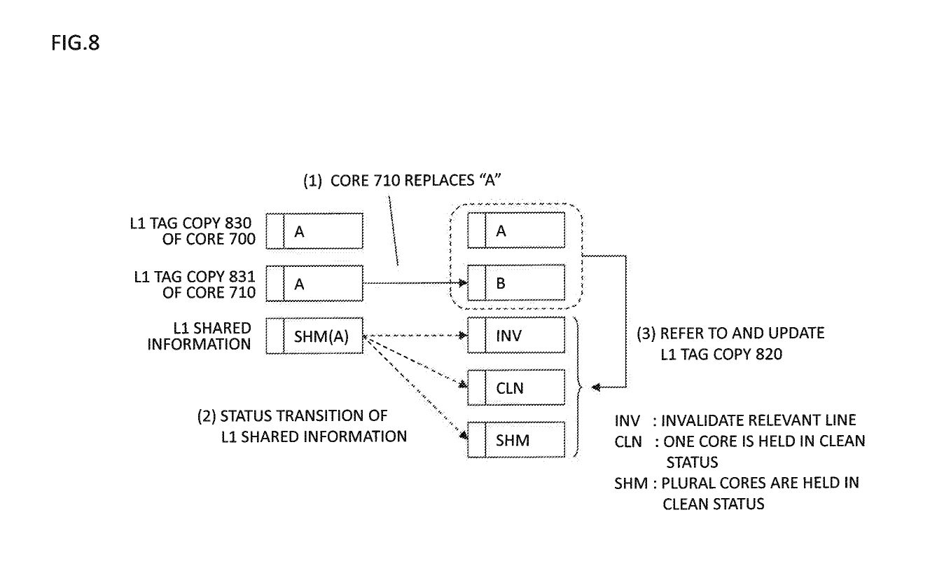

FIG. 8 illustrates how the status of the L1 shared information 811 transitions. An abbreviation “SHM” represents a (Shared Modified) status in which the data cached in the line of the L2 cache takes a non-update status (clean status) and is shared between the plurality of cores (L1 caches). Further, a status “CLN” represents a status in which the data cached in the line of the L2 cache takes the non-update status and is retained in one core (L1 cache).

FIG. 8 illustrates such a situation that the L1 cache 701 of the core 700 and the cache 711 of the core 710 cache the data associated with an address A, in which case the L1 REPLACE of the address A occurs in the core 710. In this situation, the L1 shared information 811 associated with the address A is updated into the status “CLN” or “SHM”. Specifically, if the cores other than the core 700 do not retain the data associated with the address A, the L1 shared information 811 is updated into the status “CLN”. Further, whereas if the cores other than the core 700 retain the data associated with the address A, the L1 shared information 811 remains in the status “SHM”. In any case, the determination about the shared status of the data associated with the address A is made by referring to the L1 tag copy 820 in order to update the L1 shared information 811.

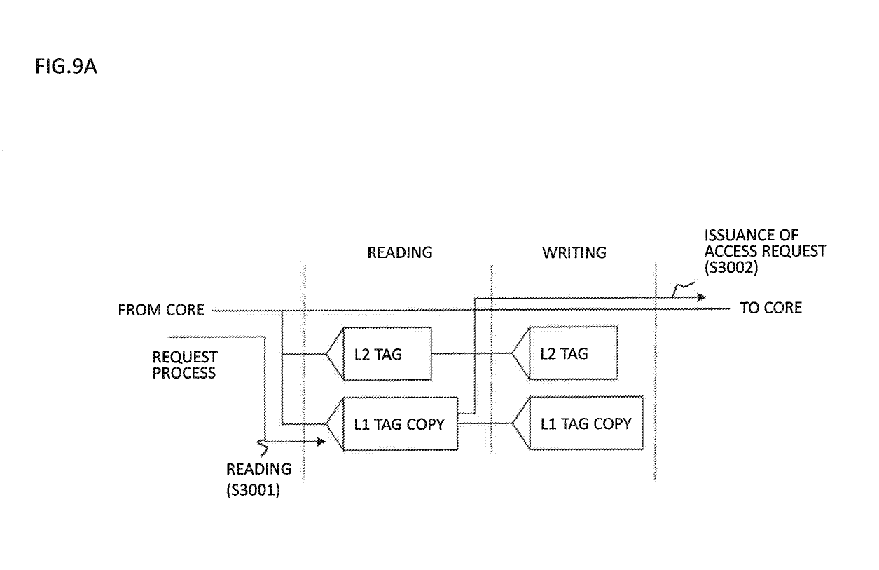

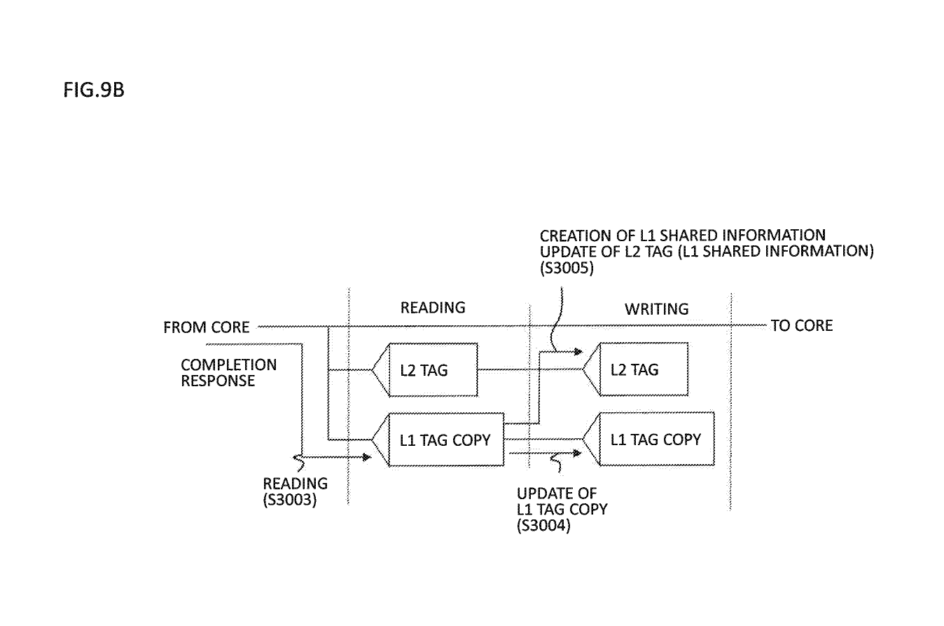

FIGS. 9A and 9B illustrate operational examples in the case of updating the L1 tag copy 820 when the L2 cache 800 receives the completion response from the core. In this case, to begin with, as depicted in FIG. 9A, in the L2 cache 800, the L2 cache control unit 840 retrieves the line that caches the REPLACE request data in response to the access request given from the core. Furthermore, the L2 cache control unit 840 reads the entry, which stores the cache tag associated with the REPLACE target address, of the L1 tag copy 820 (S3001). Next, the L2 cache 800 requests, based on the readout data, the core issuing the access request based on the L1 REPLACE to execute this L1 REPLACE (S3002).

Upon completing the processes related to the L1 REPLACE, as illustrated in FIG. 9B, the core issues, to the L2 cache 800, notification (completion response) indicating that the processes related to the L1 REPLACE are completed (S3003). In the L2 cache 800, the L2 cache control unit 840 overwrites the cache tag associated with the REPLACE request address on the entry of the L1 tag copy of the core issuing the access request based on the L1 REPLACE in accordance with the completion response given from the core (S3004). Then, the L2 cache control unit 840 updates, in the same way as in S2005, the L1 shared information 811 associated with the REPLACE target address by referring to the L1 tag copy 820 (S3005).

Patent documents 1-3 do not describe the method of processing the plurality of access requests individually occurring at the same timing for the same line described as such. Moreover, the conventional methods are incapable of simultaneously processing the plurality of access requests individually occurring at the same timing for the same line described as such. The conventional methods provide a restriction that a simultaneous issuance count of orders such as L1 REPLACE for the same line is limited up to “1”. Specifically, the L2 cache control unit 840 is provided with a mechanism for getting the subsequent access request to be retried till completing the order for relevant the cache line so that the plurality of orders for the same line do not occur simultaneously.

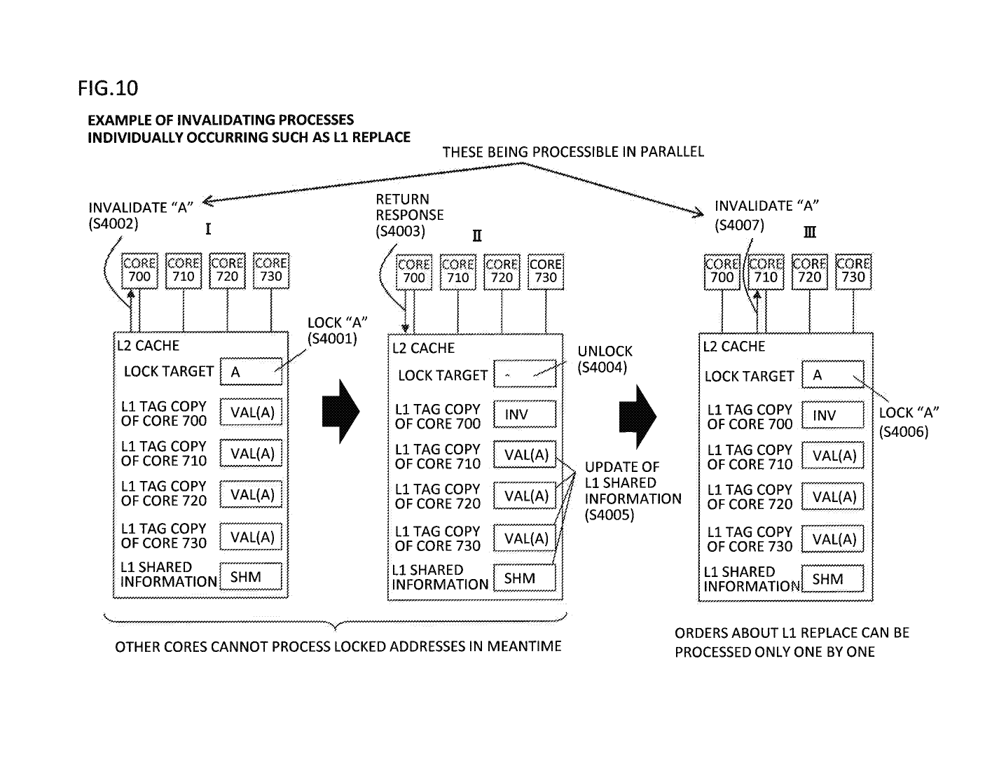

FIG. 10 illustrates an operational example in such a case that the access requests related to the plurality of L1 REPLACEs occur for the same line in the conventional method. To be specific, FIG. 10 depicts a situation of invalidating the relevant lines in the L1 caches of the respective cores on the basis of the L1 REPLACEs targeted at the address A that occur at the same timing in the core 700 and the core 710.

At first, the address A is set as a lock target on the basis of the access request given from the core 700 (S4001). This address A is set as the lock target, during which execution of processes related to the access requests to the address A from other cores is inhibited. Then, the L2 cache 800 requests the core 700 to invalidate the data specified by the address A (S4002).

Upon completing the invalidation of the data in the core 700, the core 700 returns a completion response to the L2 cache 800 (S4003). The address A is unlocked in the L2 cache 800 in accordance with the completion response (S4004). Then, the L1 tag copy 820 is referred to, and the L1 shared information 811 related to the address A is updated (S4005). Herein, the data related to the address A is shared among the core 710, the core 720 and the core 730, and therefore the L1 shared information 811 remains in the status “SHM” indicating that the L1 shared information 811 is shared among the plural cores.

Note that the update of the L1 tag copy 830 of the core 700 may be executed at any timing such as when issuing the order based on the access request for the L1 REPLACE and when making the response to the order. For example, the update of the L1 tag copy 830 of the core 700 is executed between S4001 and S4002 or between S4004 and S4005.

Thereafter, the process for the access request given from the core 710 is executed. Note that S4006 and S4007 in FIG. 10 correspond to S4001 and S4002, respectively.

Herein, the process in S4002 and the process in S4007 are the processes in the different cores and can be therefore originally conducted in parallel. The conventional methods are, however, incapable of conducting these processes in parallel. Consequently, as the core count rises, such a possibility increases that these plural processes occur, resulting in a problem that the latency is deteriorated.

An embodiment according to one aspect of the present invention will hereinafter be described on the basis of drawings. However, the embodiment, which will hereinafter be described, is no more than an exemplification of the present invention in every respect but is not designed to limit the scope of the invention. It is a matter of course that a variety of improvements and modifications can be made without deviating from the scope of the present invention. Namely, specific elements corresponding to the present embodiment may be properly adopted on the occasion of carrying out the present invention. It is to be noted that the embodiment according to one aspect of the present invention will hereinafter be also referred to as the “present embodiment”.

The present embodiment, which will hereinafter be described, exemplifies a 2-level cache memory. The present invention may, however, be applied to cache memories other than the 2-level cache memory. First level caches in the following embodiment may also be referred to as “first cache memories” when taking account of a case of being applied to 3-level or larger-level cache memory. Moreover, a second level cache in the following embodiment may also be referred to as a “second cache memory”.

Note that data occurring in the present embodiment are described in a natural language (Japanese etc.). These pieces of data are, however, specified concretely by a quasi-language, instructions, parameters, a machine language, etc., which are recognizable to a computer.

§1 Example of Apparatus

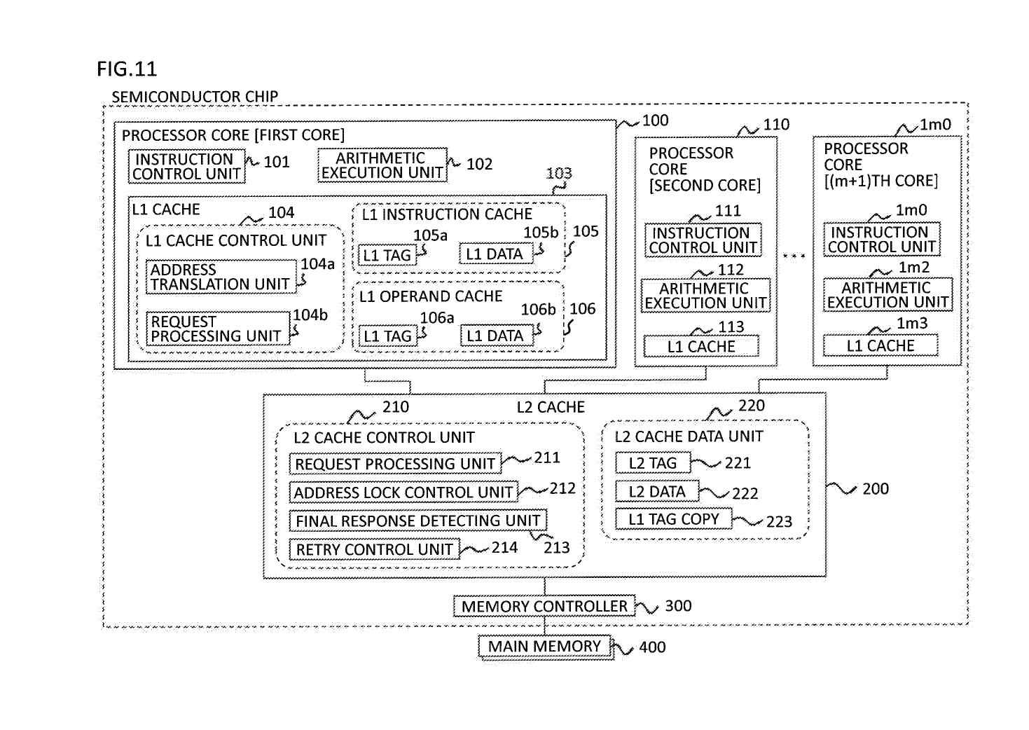

At first, an example of an apparatus according to the present embodiment will hereinafter be described by use of FIG. 11.

FIG. 11 illustrates a multi-core processor system according to the present embodiment. As depicted in FIG. 11, the multi-core processor system according to the present embodiment includes (m+1) pieces of processor cores (100, 110, . . . , 1m0), an L2 cache 200, a memory controller 300 and a main memory 400. Note that the symbol “m” connotes a natural number. In the present embodiment, the units exclusive of the main memory 400 are provided on one semiconductor chip. The multi-core processor system according to the present embodiment does not, however, limit the present invention. A relationship between the semiconductor chip and each unit is properly determined.

The processor cores (100, 110, . . . , 1m0) includes instruction control units (101, 111, . . . , 1m1), arithmetic execution units (102, 112, . . . , 1m2) and L1 caches (103, 113, . . . , 1m3), respectively. Note that the processor cores (100, 110, . . . , 1m0) are, as illustrated in FIG. 11, also referred to as a “first core”, a “second core” and an “(m+1)th core”, respectively. Moreover, each of the processor cores (100, 110, . . . , 1m0) corresponds to an arithmetic processing unit.

The instruction control units (101, 111, . . . , 1m1) are control units that perform decoding instructions and controlling processing sequences in the respective processor cores (100, 110, . . . , 1m0). To be specific, the instruction control units (101, 111, . . . , 1m1) fetch instructions (machine instructions) from storage devices. The storage devices storing the machine instructions are exemplified by the main memory 400, the L2 cache 200, the L1 caches (103, 113, . . . , 1m3). Then, the instruction control units (101, 111, . . . , 1m1) interpret (decode) the fetched instructions. Further, the instruction control units (101, 111, . . . , 1m1) acquire processing target data in the instructions from the storage device plurality of the respective processor cores (100, 110, . . . , 1m0). Subsequently, the instruction control units (101, 111, . . . , 1m1) control execution of the instructions for the acquired data.

The arithmetic execution units (102, 112, . . . , 1m2) perform arithmetic processes. Specifically, the respective arithmetic execution units (102, 112, . . . , 1m2) execute the arithmetic processes corresponding to the instructions interpreted by the individual instruction control units (101, 111, . . . , 1m1) with respect to the data being read to the registers etc.

The L1 caches (103, 113, . . . , 1m3) and the L2 cache 200 are cache memories that temporarily retain the data processed by the arithmetic execution units (102, 112, . . . , 1m2).

The L1 caches (103, 113, . . . , 1m3) are respectively cache memories dedicated to the processor cores (100, 110, . . . , 1m0). Further, the L1 caches (103, 113, . . . , 1m3) are split cache memories in which the caches are split into the instruction (IF) caches and the operand caches. The instruction cache caches the data requested by an instruction access. The operand cache caches the data requested by a data access. Note that the operand cache is also called a data cache. The split cache memory, by splitting the caches based on types of the data to be cached, enables a cache processing speed to be increased to a greater degree than an integrated cache memory, in which the caches are not split. It does not, however, mean that a structure of the cache memory used in the present invention is limited to the split cache memory.

On the other hand, the L2 cache 200 is a cache memory shared among the processor cores (100, 110, . . . , 1m0). The L2 cache 200 is classified as the integrated cache memory which caches the instruction and the operand without any distinction therebetween. Note that the L2 cache 200 may also be separated on a bank-by-bank basis for improving a throughput.

Herein, the L1 caches (103, 113, . . . , 1m3) can process the data at a higher speed than the L2 cache 200 but have a smaller in data storage capacity than the L2 cache 200 has. The processor cores (100, 110, . . . , 1m0) compensate a difference in processing speed from the main memory 400 with the use of the L1 caches (103, 113, . . . , 1m3) and the L2 cache 200, which are different in terms of their processing speeds and capacities.

Note that in the present embodiment, the data cached in the L1 caches (103, 113, . . . , 1m3) are cached also in the L2 cache 200. Namely, the caches used in the present embodiment are defined as inclusion caches configured to establish such a relationship that the data cached in the high-order cache memories closer to the processor cores are included in the low-order cache memory.

For example, the L2 cache 200, when acquiring the data (address block) requested by the processor core from the memory, transfers the acquired data to the L1 cache and simultaneously registers the data in the L2 cache 200 itself. Further, the L2 cache 200, after the data registered in the L1 cache has been invalidated or written back to the L2 cache 200, writes the data registered in the L2 cache 200 itself back to the memory. The operation being thus done, the data cached in the L1 cache is included in the L2 cache 200.

The inclusion cache has an advantage that a structure and control of the cache tag are more simplified than other structures of the caches. The cache memory used in the present invention is not, however, limited to the inclusion cache.

Moreover, a data storage structure of the L1 caches (103, 113, . . . , 1m3) and the L2 cache 200 involves adopting a set associative scheme. As discussed above, the lines of the L1 caches (103, 113, . . . , 1m3) are expressed by the L1 indices and the L1 ways. Further, the lines of the L2 cache 200 are expressed by the L2 indices and the L2 ways. Note that a line size of each of the L1 caches (103, 113, . . . , 1m3) is to be the same as a line size of the L2 cache 200.

As illustrated in FIG. 11, the L1 cache 103 includes an L1 cache control unit 104, an L1 instruction cache 105 and an L1 operand cache 106. The L1 cache control unit 104 contains an address translation unit 104a and a request processing unit 104b. Further, the L1 instruction cache 105 and the L1 operand cache 106 contain L1 tags (105a, 106a) and L1 data (105b, 106b), respectively. Note that in the present embodiment, each of the L1 caches (113, . . . , 1m3) is configured in the same way as the L1 cache 103 is.

The address translation unit 104a translates a logical address specified by the instruction fetched by an instruction control unit 101 into a physical address. This address translation may involve using a TLB (Translation Look aside Buffer) or a hash table, etc.

Moreover, the request processing unit 104b processes a cache data operation based on the instruction controlled by the instruction control unit 101. For example, the request processing unit 104b retrieves the data associated with the data request given from the instruction control unit 101 from within the L1 instruction cache 105 or the L1 operand cache 106. When the relevant data is retrieved, the request processing unit 104b sends the retrieved data back to the instruction control unit 101. Whereas when the relevant data is not retrieved, the request processing unit 104b sends a result of a cache mishit back to the instruction control unit 101. Note that the request processing unit 104b processes also the operation for the data within the L1 cache on the basis of the L1 REPLACE described above. Moreover, the request processing unit 104b executes also a process of writing the data specified by the request given from the L2 cache 200 back to the L2 cache 200 on the basis of this request.

The L1 instruction cache 105 and the L1 operand cache 106 are storage units that store the data of the L1 cache 103. The L1 instruction cache 105 caches the machine instruction to be accessed when fetching the instruction. Further, the L1 operand cache 106 caches data specified in an operand field of the machine instruction.

The L1 tags (105a, 106a) respectively store cache tags of the L1 instruction cache 105 and the L1 operand cache 106. An address of the data cached in the line is specified by the cache tag and the L1 index. Further, the L1 data (105b, 106b) store pieces of data associated with the addresses specified respectively by the L1 indices and the L1 tags (105a, 106a).

Moreover, as illustrated in FIG. 11, the L2 cache 200 includes an L2 cache control unit 210 and an L2 cache data unit 220. The L2 cache control unit 210 includes a request processing unit 211, an address lock control unit 212, a final response detecting unit 213 and a retry control unit 214. Furthermore, the L2 cache data unit 220 contains an L2 tag field 221, L2 data field 222 and an L1 tag copy field 223.

The request processing unit 211 executes the processes related to the access requests given from the processor cores (100, 110, . . . , 1m0). Further, the request processing unit 211 issues the access requests to the respective processor cores (100, 110, . . . , 1m0) on the basis of the executed processes. The L2 cache 200 according to the present embodiment includes one or more pipelines (unillustrated). The request processing unit 211 can process in parallel the access requests given from the respective processor cores (100, 110, . . . , 1m0) through the pipelines. Note that the instruction control unit 101 issues the access request given from the processor core 100 in the present embodiment.

The access request contains a data request issued if the cache mishit occurs, e.g., in the L1 cache. For example, the instruction control unit 101 is to acquire the data from the L1 cache 103 on the occasion of fetching the instruction and performing a data access operation. At this time, if the target data is not cached in the L1 cache 103, the cache mishit occurs. When the cache mishit occurs, the instruction control unit 101 is to acquire the target data from the L2 cache 200. The data request is the access request issued on this occasion from the core to the L2 cache 200.

Moreover, the access request contains the access request based on, e.g., the L1 REPLACE. For instance, the instruction control unit 101 acquires the data not cached in the L1 cache 103 from the L2 cache 200 or the main memory 400. On this occasion, the instruction control unit 101 requests the request processing unit 104b to store the acquired data in the L1 cache 103. An assumption is that the L1 REPLACE occurs at this time. As described above, when the L1 REPLACE occurs, the data processing is carried out within the L1 cache with the occurrence of the L1 REPLACE and within the L2 cache. The access request based on the L1 REPLACE is the access request issued by the instruction control unit 101 in order to execute the data processing within the L2 cache at this time.

Note that, e.g., if these processes are executed on the occasion of the instruction fetch, the acquired data is cached in the L1 instruction cache 105. Further, for instance, if these processes are executed on the occasion of accessing the data associated with the operand field of the machine instruction, the acquired data is cached in the L1 operand cache 106.

The request processing unit 211 keeps the coherency between the L1 caches (103, 113, . . . , 1m3) and the L2 cache 200 and thereafter executes the processes related to these access requests. The request processing unit 211 controls the cache coherency between the L1 caches (103, 113, . . . , 1m3) and the L2 cache 200. Hereat, the request processing unit 211 requests the processor cores (100, 110, . . . , 1m0) to perform invalidating the lines and executing the write-back process with respect to the L1 caches in order to keep the cache coherency. It is to be noted that the instruction of the process related to the access request given from the core will hereinafter be also referred to as an “order”. Further, the access request may also be termed a “processing request” inclusive of the related process such as acquiring the target data of the access request.

With respect to the access request flowing on the pipeline from the core, the address lock control unit 212 sets, as a lock target, the cache block specified by information indicating a target address of the access request and an access request issuer core. Then, the address lock control unit 212 manages the execution of the subsequent access request with respect to the lock target cache block.

Additionally, with respect to the access request flowing on the pipeline from the processor core, the address lock control unit 212 registers, in a retaining unit (unillustrated), the information indicating the target address of the access request and the processor core as the access request issuer. This retaining unit is provided within the L2 cache 200. With this contrivance, the address lock control unit 212 sets, as the lock target, the cache block specified by the address and the processor core that are indicated by the information described above, and cancels executing the process related to the subsequent access request about this cache block.

Note that the information retained by the address lock control unit 212 may take whatever format if being the information in a format making identifiable both of the access request target address and the processor core having issued the access request. The access request target address corresponds to a “control target address” to specify a control target cache block. Moreover, the information indicating the processor core as the access request issuer corresponds to control target identifying information for specifying an arithmetic processing unit as a control target access requester.

For example, this information may contain address information indicating the access request target address and core identifying information indicating the processor core having issued the access request. Herein, the core identifying information is exemplified by a core number etc. for identifying the processor core. Further, the information registered in the retaining unit may contain data type information indicating a type of the data stored in the specified address. The data type information is the information indicating whether the target data is the data related to the machine instruction or the data specified in the operand field of the machine instruction. Note that the data related to the machine instruction is the data cached in the instruction cache. Furthermore, the data specified in the operand field of the machine instruction is the data cached in the operand cache.

Moreover, for instance, the information indicating the access request target address and the access request issuer core may be the address information stored on a per processor core basis. In this case, the address information is stored on the per processor core basis, and hence, even if the core identifying information specifying the processor core is not contained in this address information, the processor core related to the lock target cache block can be identified from the address information.

The address lock control unit 212 re-inputs the subsequent access request with its processing execution being cancelled onto the pipelines. Further, the address lock control unit 212 cancels setting the lock target cache block based on the preceding access request in a way that corresponds to the completion response for notifying that the process requested based on the preceding access request has been completed.

This setting being cancelled, if the access requests for the same cache block flow on the pipelines, the execution of the process related to the subsequent access request is cancelled for a period till completing the process related to the preceding access request, and the retry process is made.

Namely, on the occasion of executing the process related to the access request given from the processor core, the address lock control unit 212 locks the cache block becoming the target block of the execution-related access request. This cache block is thus locked, during which the address lock control unit 212 cancels executing the processes related to other access requests for the locked cache block and continues to re-input the other access requests onto the pipelines.

Then, upon completing the process related to the access request given from the processor core, the L2 cache control unit 210 (the address lock control unit 212) receives the notification (the completion response) indicating that the process requested based on the access request has been completed. This completion response is transmitted from, e.g., the processor core having issued the access request.

The address lock control unit 212 cancels, corresponding to the completion response, the lock based on the access request with this completion response being made. The lock is canceled by invalidating the unlocking target data (information). The invalidation of the data may be attained by deleting the data and may also be attained by using a flag indicating that the data is invalid.

When the cache block is unlocked, it is feasible to execute the process related to the access request for the unlocked cache block. Namely, other access requests kept continuously being re-inputted onto the pipelines can be processed. Hence, the processes related to other access requests, which are re-inputted onto the pipelines, are executed after unlocking the target cache blocks of the processes related to the other access requests.

The final response detecting unit 213 makes a determination about the final completion response in the completion responses of the processes related to the plurality of access requests issued in parallel to the cache blocks specified by the same address. The final response detecting unit 213, if capable of making the determination about the final completion response, may take whatever method to attain this. One example of the final response detecting unit 213 will be described later on.

Note that the phrase “the plurality of access requests issued in parallel” connotes that each of the plurality of access requests has a period-overlapped relationship in which a period from the issuance of the order related to the access request down to the completion thereof is overlapped with the period of another access request. Incidentally, it may be sufficient that each access request contained in the plurality of access requests is overlapped with any other access request contained in the plurality of access requests in terms of the period from the issuance of the order down to the completion thereof.

For example, “the plurality of access requests issued in parallel” is defined as the plurality of access requests that is broadcasted to all the cores and serves to make the requests for invalidating the relevant lines.

Further, e.g., “the plurality of access requests issued in parallel” is also defined as the plurality of access requests that is issued in a batch to the plurality of processor cores having the relevant lines in order to make the requests for invalidating these lines.

Moreover, for instance, “the plurality of access requests issued in parallel” is defined as the access requests for the same cache block, which occur individually at the same timing in the plurality of processor cores. “The access requests for the same cache block, which occur individually at the same timing in the processor cores” are the access requests based on, e.g., the L1 REPLACE. In the present embodiment, the address information and the core number for identifying the processor core as the access request issuer are set by way of the information for specifying the lock target cache block. Therefore, the processes related to the access requests for the same cache block, which occur individually in the different processor cores, are not inhibited from being executed but can be executed in parallel.

The retry control unit 214, if the access requests for the same address as the target address of the access request issued corresponding to the final completion response exist on the pipelines, cancels executing the access requests issued corresponding to the final completion response. Further, the retry control unit 214 re-inputs, onto the pipelines, the access requests issued corresponding to the final completion response with the processing execution being cancelled. With this re-inputting, the retry control unit 214 retries executing the processes related to the access requests issued corresponding to the final completion response with the processing execution being cancelled. Note that an in-depth description thereof will be made later on. In a control example described later on according to the present embodiment, the process related to the access request issued corresponding to the final completion response is an update process of the L1 shared information.

The L2 cache control unit 210 controls, through these units, the processes related to the access requests issued by the processor cores. The system according to the present embodiment improves deterioration of latency, which is consequent upon an increase in number of the processor cores, under the control of the L2 cache control unit 210. Incidentally, detailed operations thereof will be described later on.

The L2 cache data unit 220 is a storage unit for storing the data of the L2 cache 200. An L2 tag 221 stores cache tags of the L2 cache 200. An address of the data cached in the line within the L2 cache 200 is specified by the cache tag and the L2 index. Further, the L2 data 222 stores pieces of data associated with the addresses specified by the L2 indices and by the tags in the L2 tag 221. Moreover, an L1 tag copy 223 stores copies of the cache tags of the L1 caches (103, 113, . . . , 1m3). The L1 tag copy 223 is stored with, e.g., the copies of the L1 tags (105a, 106a).

Note that the multi-core processor system according to the present embodiment includes, as illustrated in FIG. 11, the memory controller 300 and the main memory 400. The memory controller 300 processes writing and reading the data to and from the main memory 400. For example, the memory controller 300 writes write-back target data to the main memory 400 in accordance with a data write-back process executed by the request processing unit 211. Further, the memory controller 300 reads, in response to a data request given from the request processing unit 211, the request-related data from the main memory 400. It is to be noted that the main memory 400 is a main storage device utilized in the multi-core processor system according to the present embodiment.

§2 Data Formats

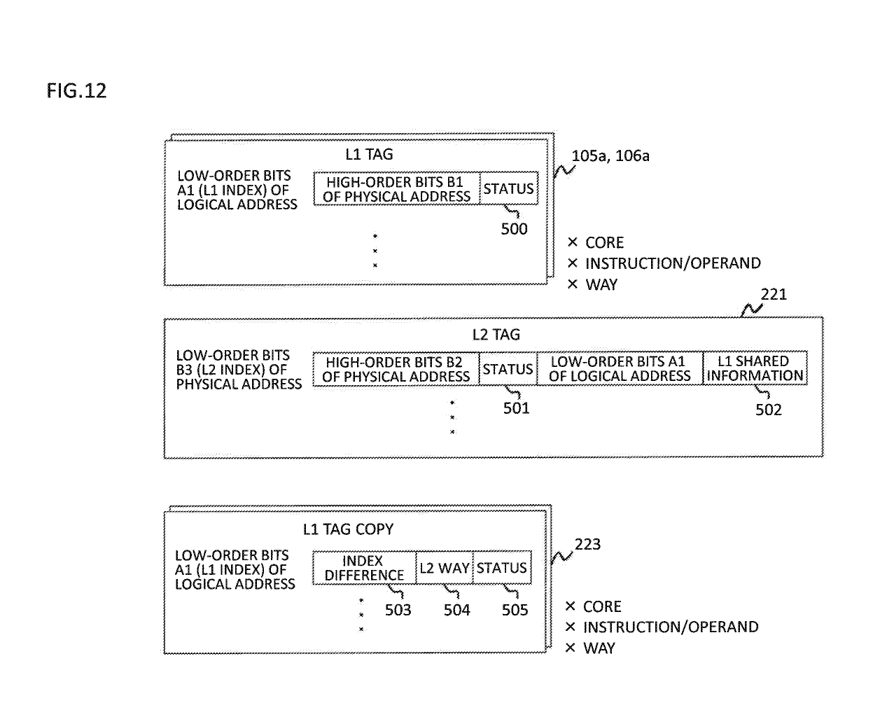

Next, data formats of the cache tags treated in the present embodiment will be described by use of FIG. 12. FIG. 12 illustrates data formats of the cache tags cached in the L1 caches (103, 113, . . . , 1m3) and in the L2 cache 200. Note that FIG. 12 illustrates the data formats of the cache tags for a single line.

An example depicted in FIG. 12 is that each of entries of the L1 tags (105a, 106a) has fields for storing a physical address high-order bit B1 and a status 500. The physical address high-order bit B1 is used for retrieving the line. Further, the status 500 is defined as information indicating whether the data cached in the line associated with the cache tag is valid or not, whether the data is updated or not, and so on. The data cached in the L1 cache is retrieved based on the thus-structured L1 tag.

To be specific, at first, the request processing unit 104b retrieves a set allocated with the L1 index coincident with low-order bits of a logical address allocated from the instruction control unit 101 from within the L1 instruction cache 105 or the L1 operand cache 106. If being an operation at a stage of fetching the instruction, the request processing unit 104b retrieves the relevant set from the L1 instruction cache 105. Further, if being an operation in the process of acquiring the data specified in the operand field of the machine instruction, the request processing unit 104b retrieves this relevant set from the L1 operand cache 106.

Next, the request processing unit 104b retrieves, from within the relevant set, the line cached with the data specified by the logical address allocated from the instruction control unit 101. This retrieval is done by using the physical address. Hence, the address translation unit 104a translates, into the physical address, the logical address allocated from the instruction control unit 101 before this retrieval.

Namely, in the L1 cache 103, the index is given by the logical address (virtual address), while the cache tag is given by a real address (physical address). This type of method is called a VIPT (Virtually Indexed Physically tagged) method.

The address allocated from the core is the logical address. Therefore, according to a PIPT (Physically Indexed Physically Tagged) method of giving the index by the physical address, the relevant line is retrieved after performing the translation process from the logical address into the physical address. By contrast with this method, according to the VIPT method, the specifying process of the index and the translation process from the logical address into the physical address can be done in parallel. Hence, the VIPT method is smaller in latency than the PIPT method.

Moreover, in a VIVT (Virtually Indexed Virtually Tagged) method of giving the cache tag also by the logical address, such a problem (homonym problem) arises that different physical addresses are allocated to the same virtual address. The VIPT method involves applying the physical address to the cache tag and is therefore capable of detecting the homonym problem.

These advantages lead to adopting the VIPT method for the caches used in the present embodiment. It does not, however, mean that the caches used in the present invention are limited to the VIPT method. Note that the logical address is translated into the real address in the L1 cache 103, and therefore the addresses used in the lower-order caches than the L1 cache 103 are the real addresses in the present embodiment.

The request processing unit 104b compares the high-order bits of the physical address translated by the address translation unit 104a with the high-order bits B1 of the physical address of each entry of the L1 tag. The line associated with the entry of the L1 tag containing the high-order bits B1 of the physical address, which are coincident with the high-order bits of the physical address translated by the address translation unit 104a, is the line cached with the data specified by the logical address allocated by the instruction control unit 101. Hence, the request processing unit 104b retrieves the L1 tag entry containing the high-order bits B1 of the physical address coincident with the high-order bits of the allocated physical address from within the L1 tag associated with the line contained in the retrieved set.

Finally, as a result of the retrieval, when detecting the entry of the relevant L1 tag, the request processing unit 104b acquires the data cached in the line associated with the entry of the relevant L1 tag, and hands over the acquired data to the instruction control unit 101. Whereas when not detecting the entry of the relevant L1 tag, the request processing unit 104b determines that the result is the cache mishit, and notifies the instruction control unit 101 that the specified data is not cached in the L1 cache 103. In the present embodiment, the data cached in the L1 caches are thus retrieved.

Note that the entries of the L1 tags are prepared on a per core basis, a per data type basis, a per index basis and a per way basis. FIG. 11 illustrates that the entries of the L1 tags are prepared on the per core basis, the per index basis and the per data type basis. Moreover, in the present embodiment, the data storage structure of the L1 caches (103, 113, . . . , 1m3) adopts the set associative scheme, and hence the entries of the L1 tags are prepared on the per way basis.

Further, in an example depicted in FIG. 12, each of entries of the L2 tag 221 has fields for storing physical address high-order bits B2, a status 501, logical address low-order bits A1 and L1 shared information 502.

The physical address high-order bits B2 are used for retrieving the line in the L2 cache 200. The status 501 is defined as information indicating, in the L2 cache 200, whether the data cached in the line associated with the cache tag is valid or not, whether the data is updated or not, and so on.

Moreover, the logical address low-order bits A1 are used for obviating, e.g., a synonym problem. The present embodiment adopts the VIPT method in the L1 caches. Hence, there is a possibility that the synonym problem arises, in which the different logical addresses are allocated to the same physical address. In the present embodiment, it is feasible to detect whether the synonym problem arises or not by referring to the logical address low-order bits A1.

The L1 shared information 502 is information indicating the shared status among the L1 caches (103, 113, . . . , 1m3) with respect to the data cached in the lines associated with the cache tags (refer to, e.g., Patent documents 2 and 3). A field storing the L1 shared information 502 is provided in place of the field storing the L1 tag copy 223 in order to reduce a physical quantity of the L2 tag 221. The data cached in the L2 cache 200 is retrieved by use of the L2 tag 221 described as such.

The data retrieval can be described substantially in the same way as the retrieval process in the L1 cache 103 is described. Specifically, the request processing unit 211 retrieves, to begin with, the set allocated with the L2 index coincident with the low-order bits of the physical address contained in the access request given from the core. It is to be noted that the address of the processing target contained in the access request given from the core will hereinafter be referred to as a “request address”.

Next, the request processing unit 211 retrieves the line caching the data specified by the request address allocated from the core in the lines contained in the relevant set. To be specific, the request processing unit 211 retrieves, from within the L2 tag 221 associated with the lines contained in the retrieved set, the entry of the L2 tag 221 containing the physical address high-order bits B2 coincident with the high-order bits of the request address allocated from the core.

Finally, as a result of the retrieval, when detecting the entry of the relevant L2 tag 221, the request processing unit 211 acquires the data cached in the line associated with the entry of the relevant L2 tag 221, and hands over the acquired data to the core having issued the access request. Whereas when not detecting the entry of the relevant L2 tag 221, the request processing unit 211 determines that the result is the cache mishit. Then, the request processing unit 211 requests the memory controller 300 for the data specified by the request address. The memory controller 300 acquires the requested data from the main memory 400 in response to the request given from the request processing unit 211, and hands over the acquired data to the L2 cache 200.

Note that the data storage structure of the L2 cache adopts the set associative scheme in the present embodiment, and hence the entries of the L2 tag 221 are prepared on the per index basis and the per way basis.

Moreover, a data storage capacity of the L2 cache 200 is larger than the data storage capacity of the L1 cache 103. Then, in the present embodiment, a line size of the L1 cache 103 is the same as the line size of the L2 cache 200. Therefore, normally, the number of sets of the L2 cache 200 is larger than the number of sets of the L1 cache 103. In this case, a bit length of the L2 index is larger than the bit length of the L1 index. Hence, in this instance, a bit length of the physical address high-order bits B2 is smaller than the bit length of the physical address high-order bits B1. It is, however, considered that the bit length of the physical address high-order bits B1 may be smaller than and may also be the same as the bit length of the physical address high-order bits B2 depending on the cache capacities, the number of ways, etc. thereof. These relationships are properly selected.

Further, in the example illustrated in FIG. 12, each of the entries of the L1 tag copy 223 has fields for storing an index difference 503, an L2 way 504 and a status 505.

The index difference 503 is a difference between the logical address low-order bits A1 and physical address low-order bits B3. Further, the L2 way 504 stores information for specifying the way of the line of the L2 cache, which is associated with the L1 tag copy 223. In the present embodiment, the data cached in the L1 caches are to be cached in the L2 cache, thereby specifying the L2 way 504. Through the index difference 503 and the L2 way 504, the entry of the L1 tag copy 223 is associated with the entry of the L2 tag 221 (refer to Patent document 3). Note that the status 505 is defined as information indicating, in the L1 caches (103, 113, . . . , 1m3), whether the data cached in the line associated with the cache tag is valid or not, whether the data is updated or not, and so on.

Incidentally, according to the L1 tag copy 223 described above, the L2 cache 200 can execute retrieving the relevant entry of the L1 tag copy 223 by use of the retrieval result of the L2 tag 221.

To be specific, the request processing unit 211 refers to the L2 tag 221 in order to retrieve the relevant data from the L2 cache 200. If the relevant data exists within the L2 cache 200, the entry in the L2 tag 221 associated with the line caching the relevant data is retrieved through the retrieval of the L2 tag 221 by using the physical address of the relevant data. This retrieval being thus done, it is feasible to specify the L2 index related to the retrieval target data and the L2 way. The L1 index related to the retrieval target data is specified by a part of the L2 index or by the logical address low-order bits A1 in the L2 tag 221. Hence, the L1 index and the L2 index related to the retrieval target data and the L2 way are specified through the retrieval of the L2 tag 221.

Herein, the entry of the L1 tag copy 223 can be specified by the L1 index, the index difference 503 and the L2 way 504. The index difference 503 is a difference between the L1 index (the logical address low-order bits A1) and the L2 index (the physical address low-order bits B3). Hence, the L2 cache 200 can specify the entry of the L1 tag copy 223 associated with the retrieval target data from the L1 index, the L2 index and the L2 way, which are specified through the retrieval of the L2 tag 221.

Note that the L1 index related to the retrieval target data is contained in the L2 index as the case may be. In this case, the L1 index may also be specified from the L2 index. Furthermore, the access request given from the core contains the information on the L1 index as the case may be. In this case, the L1 index may also be specified from the information contained in the access request given from the processor core. It is to be noted that the information on the L1 index, which is contained in the access request given from the core, is, e.g., the logical address itself.

It is to be noted that the cache memory in the present embodiment is classified as the inclusion cache, and hence, if the relevant data does not exist in the L2 cache 200, this data does not exist in the L1 cache either. Therefore, it does not happen that the entry in the L1 tag copy 223 is retrieved with respect to the data not existing in the L2 cache 200.

Moreover, the logical address low-order bits A1 are contained in the physical address low-order bits B3 as the case may be in a way that depends on an associative relationship between the logical address and the physical address. In this case, the bit length of the index difference 503 is equalized to a difference between the bit length of the physical address low-order bits B3 and the bit length of the logical address low-order bits A1.

Further, if an addition of the bit length of the index difference 503 to the bit length of the L2 way 504 is smaller than the bit length of the physical address high-order bits B1, the physical quantity of the L1 tag copy 223 is reduced to a greater degree than in the case of copying the L1 tag as it is.

This L1 tag copy 223 is used mainly for keeping the coherency between the L1 caches (103, 113, . . . , 1m3) and the L2 cache 200 (refer to Patent documents 1-3). Note that the L1 tag copy 223 is prepared, for the same reason as the reason for the L1 tag, on the per core basis, the per data type basis and the per way basis.

Moreover, when referring to the L1 tag copy 223, the data retained in the L1 cache of each core can be determined, and therefore the L1 shared information 502 can be updated by employing the L1 tag copy 223.

For example, the L2 cache control unit 210 specifies the data (address) of which a shared status is indicated by the update target L1 shared information 502 on the basis of the cache tag stored in the entry of the L2 tag 221 containing the update target L1 shared information 502. Then, the L2 cache control unit 210 specifies the L1 cache to retain the target data by referring to the L1 tag copy 223, and thus determines the shared status of the target data in the L1 cache. Finally, the L2 cache control unit 210 updates the L1 shared information 502 on the basis of a result of the determination made by referring to the L1 tag copy 223. In this manner, the L2 cache control unit 210 can update the L1 shared information 502.

§3 Control Example

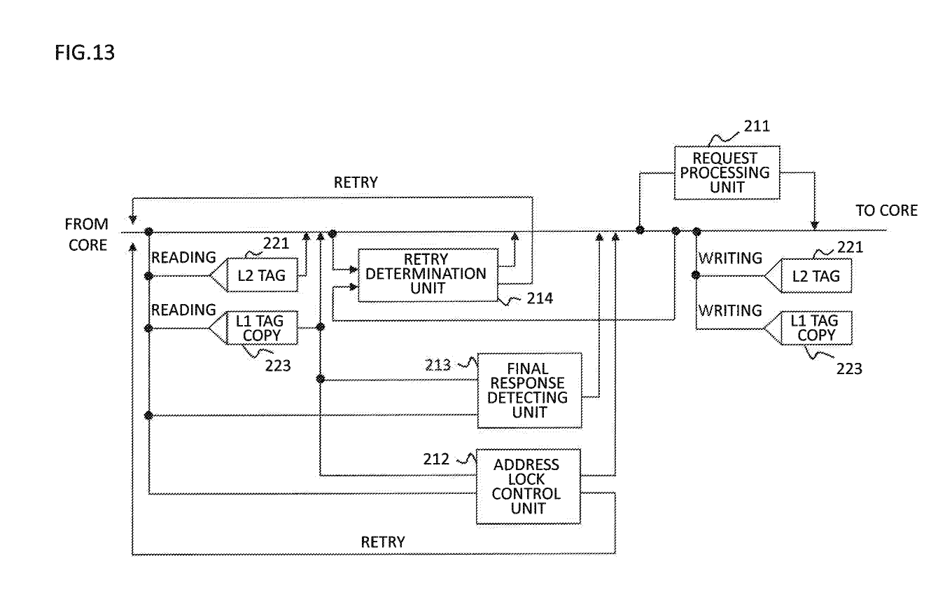

Next, a control example of the L2 cache control unit 210 according to the present embodiment will be described by use of FIGS. 13-17.

FIG. 13 illustrates control blocks of the L2 cache control unit 210 according to the present embodiment. Upon receiving the access request from the core, in the L2 cache 200, there are read items of data stored in the relevant entry of the L2 tag 221, the entry of the L1 tag copy 223 and in the relevant line, respectively. The address lock control unit 212 determines, based on the readout data, whether a cache block becoming a processing target of the process related to the access request received from the core is locked or not.

Note that the address lock control unit 212, when an order related to the process requested by the core is issued, locks the order target cache block. The cache block to be locked is specified by the address, the core number, the data type, the L2 index, the L2 way, the L1 index, the L1 way, etc. In the present embodiment, as the information indicating the locked cache block, the address and the core number of the processing target cache block are used.

The address lock control unit 212, when determining that the cache block becoming the processing target of the process related to the access request is locked, cancels executing the process related to the access request, and re-inputs the access request onto the pipeline in order to retry executing the process.

Whereas when the address lock control unit 212 determines that the cache block becoming the processing target of the process related to the access request is not locked, the request processing unit 211 executes the process related to the access request. Then, the request processing unit 211 issues the access request to the processing target core on the basis of the executed process.

Herein, e.g., the L2 cache 200 is to receive the access requests pertaining to the L1 REPLACE targeted at the same line on the L2 cache 200 from the cores different from each other. In this case, the respective access requests are issued from the different processor cores as the issuers, and hence the lock target cache blocks being locked based on the respective access requests are different. Hence, if the target cache blocks are not locked due to the preceding process, the respective access requests are processed in parallel without cancelling the executions of these access requests each other.

Thus, the address lock control unit 212 controls the access request for the cache block specified by the information retained in the retaining unit on the basis of the access target address contained in the access request issued by any one of the plurality of cores and requester identifying information specifying the core having issued the access request. It to be noted that the request address contained in the access request corresponds to the access target address in the present embodiment. Further, the core number contained in the access request corresponds to the requester identifying information.

Incidentally, in the course of processing each access request, the data stored in the entry of the L1 tag copy 223 pertaining to each access request is updated. The update of the L1 tag copy 223 may be executed at timing when making the order issuance or when making the order response.

With respect to the access request issued to the core, upon completing the process related to the access request in the core, the core notifies the L2 cache 200 that the process related to the access request has been completed (completion response). In accordance with the completion response, the address lock control unit 212 unlocks the cache block being locked based on the access request pertaining to the completion response.

Further, as for the completion responses given from the cores, the final response detecting unit 213 detects the final completion response in the completion responses of the processes related to the access requests issued in parallel at the same timing to the lines specified by the same address. For example, the final response detecting unit 213 detects the final completion response in the completion responses of the processes related to the access requests about the L1 REPLACE targeted at the same line on the L2 cache 200, these access requests being issued at the same timing in the cores different from each other.

When the final completion response is detected, in the L2 cache 200 according to the present embodiment, the update of the L1 shared information 502 contained in the relevant entry of the L2 tag 221 is executed. With respect to the access request concerning the update of this L1 shared information 502, the retry control unit 214 determines whether the process related to the access request can be executed or not.

For example, the retry control unit 214 determines whether the completion response of the process flows in advance on the pipeline or not, this process being related to the access request targeted at the line associated with the entry of the L2 tag 221 storing the L1 shared information 502 to be updated. The retry control unit 214, if the preceding completion response exists, determines that the update process of the L1 shared information 502 cannot be executed, then cancels executing the update process and re-inputs the access request related to the update process onto the pipeline. Whereas if the preceding completion response does not exist, the retry control unit 214 determines that the update process of the L1 shared information 502 can be executed, and permits executing the update process.

Note that the update process of the L1 shared information 502 is not executed for the completion responses other than the final completion response in the present embodiment. These completion responses are the completion responses for the orders related to the access requests for the same address. Namely, the L1 shared information 502 is shared with respect to the respective completion responses. Therefore, the update process of the L1 shared information 502 for the completion responses other than the final completion response results in a futile process. Hence, in the present embodiment, the update process of the L1 shared information 502 for the completion responses other than the final completion response is not executed.

The L2 cache control unit 210 according to the present embodiment processes the access requests given from the processor cores by the control method described as such. Note that the access requests to be processed may be the access requests as in the case of the batch invalidation described above and may also be the access requests occurring individually at the same timing in the present embodiment. The L2 cache control unit 210 according to the present embodiment can control also the process related to any one of the access requests.

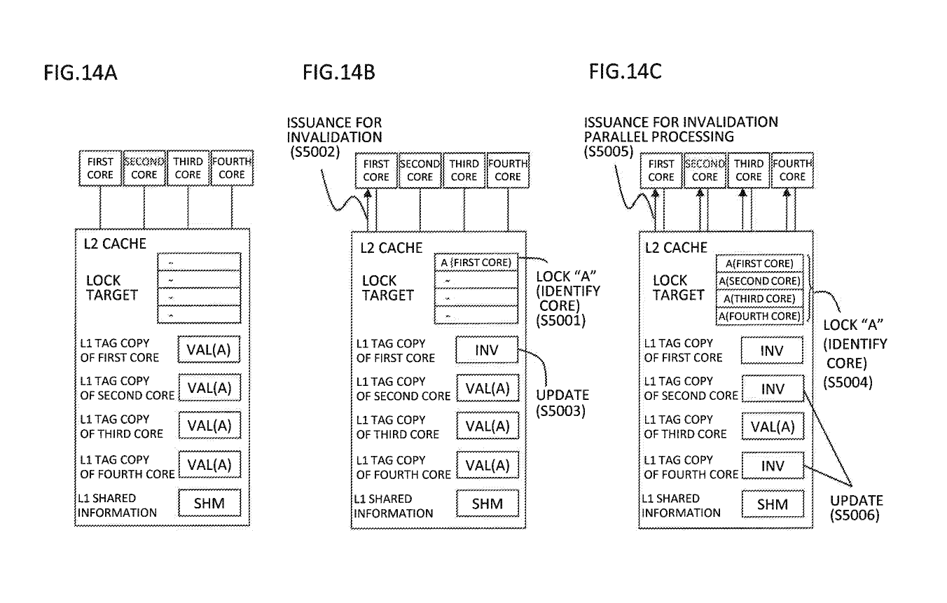

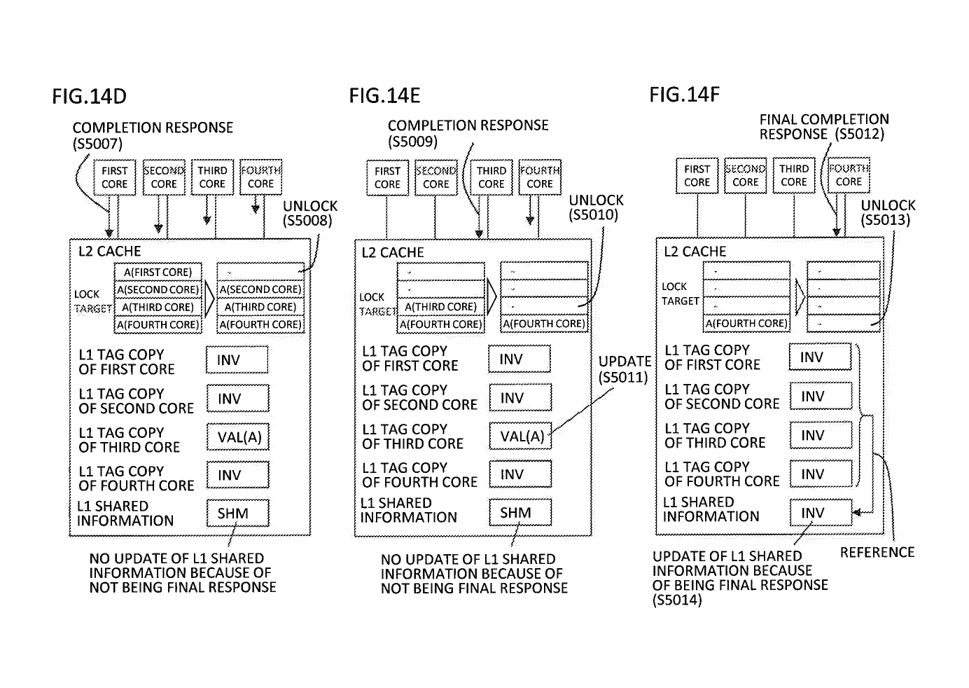

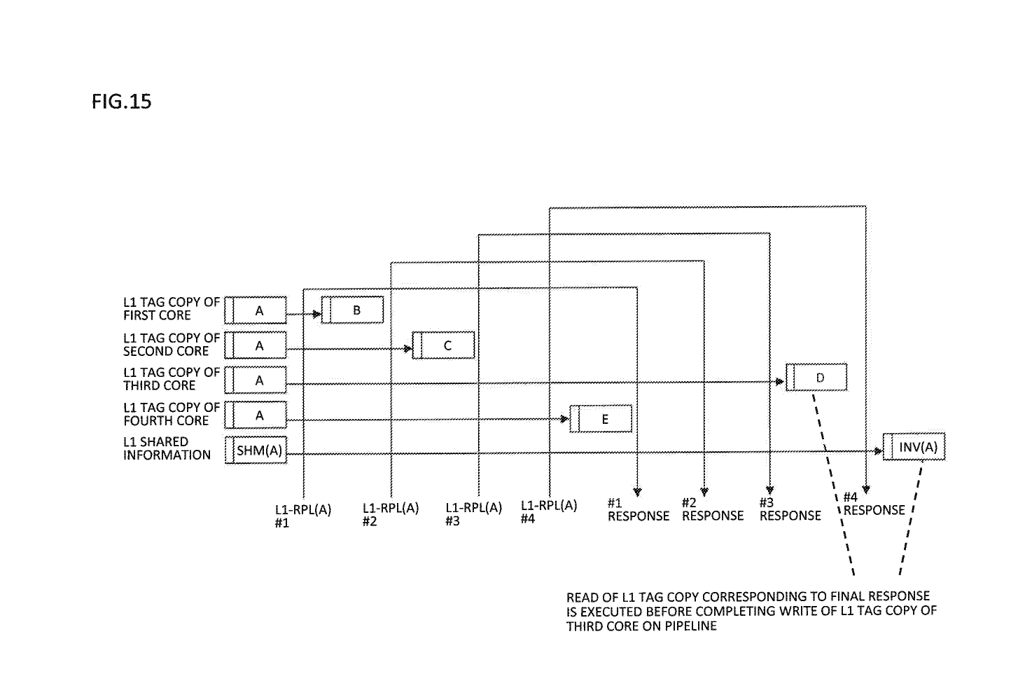

FIGS. 14A-14F illustrate operations of the L2 cache control unit 210 according to the present embodiment. FIGS. 14A-14F illustrate cases in which a core count (m+1) is “4”. Further, FIGS. 14A-14F illustrate cases in which the L2 cache 200 issues the access request of the invalidation process for the first core with respect to the access requests about the L1 REPLACE, which are issued at the same timing from all the cores, and further issues in parallel the access requests of t the invalidation processes for the second core-the fourth core.

Note that in the examples depicted in FIGS. 14A-14F, the L2 cache 200 updates the L1 tag copy when issuing the orders for issuing the access requests for the respective cores with respect to the access requests about the L1 REPLACE, which are given from the first core, the second core and the fourth core. Further, the L2 cache 200 also updates the L1 tag copy when the third core sends back the completion response to the order related to the access request after issuing the access request for the third core with respect to the access request about the L1 REPLACE, which is given from the third core. Incidentally, the L2 cache 200 according to the present embodiment may update the L1 tag copy at any timing. For instance, the L1 tag copies pertaining to the first core, the second core and the fourth core may be updated corresponding to the completion responses given from the respective cores. Moreover, the L1 tag copy related to the third core may also be updated when issuing the order pertaining to the issuance of the access request for the third core.

At first, in an initial status depicted in FIG. 14A, data associated with an address Aare retained in the L1 caches of all the cores. Therefore, as illustrated in FIG. 14A, the cache tags associated with the address A are stored in the entries of the L1 tag copies of the respective cores. In FIG. 14A, a symbol “VAL (A)” represents that the data associated with the address A is retained validly in the L1 cache. Further, in the initial status illustrated in FIG. 14A, there is no existence of the cache block registered as the lock target block. Moreover, a status value “SHM” representing that the data cached in the relevant cache line is shared between or among the plurality of cores, is stored as the L1 shared information 502 in the entry of the L2 tag 221 for storing the cache tag of the line of the L2 cache 200 cached with the data associated with the address A.

Herein, it is assumed that the requests for the L1 REPLACE are issued to the address A at the same timing in the respective cores. At this time, the L2 cache 200 receives the access requests about the L1 REPLACE from the respective cores. It is also assumed that the L2 cache 200 processes, corresponding to this operation, the access request of the first core. FIG. 14B depicts the operation of the L2 cache 200 at this time.

Hereat, the address lock control unit 212 of the L2 cache 200 locks the target cache block of the access request in response to the access request given from the first core (S5001). To be specific, the address lock control unit 212 retains the information containing the address information indicating the target address A of the L1 REPLACE and the core number for identifying the first core having issued the access request about the L1 REPLACE byway of the information indicating the lock target cache block. In FIG. 14B, “A (the first core)” is illustrated by way of one example of the information for specifying the lock target cache block.

Then, the request processing unit 211 of the L2 cache 200 issues the access request for invalidating the data about the address A to the first core (S5002). The first core executes invalidating the data about the address A on the basis of the access request.

Moreover, with respect to the access request about the L1 REPLACE that is given from the first core, the L2 cache 200 updates the L1 tag copy when issuing the access request for the first core. Therefore, the L2 cache control unit 210 of the L2 cache 200 updates the L1 tag copy of the first core (S5003). Specifically, the L2 cache control unit 210 updates, from the status “VAL(A)” into the status “INV”, the information stored in the entry of the L1 tag copy 223 associated with the cache line of the L1 cache of the first core cached with the data associated with the address A.

Next, the L2 cache 200 processes in parallel the access requests of the L2 core, the third core and the fourth core. FIG. 14C illustrates the operation of the L2 cache 200 at this time.

Hereat, the address lock control unit 212 locks the cache blocks becoming the access request targets thereof in response to the access requests given from the second core, the third core and the fourth core (S5004). In FIG. 14C, the “A(the second core)”, the “A(the third core)” and the “A(the fourth core)” represent access originators with respect to the cache blocks to be locked at this time. The respective access requests for the cache blocks registered as the lock target blocks are the access requests targeted at the address A. However, the cores having issued the access requests are different from each other, and hence these access requests can be processed in parallel. Therefore, in the present embodiment, the respective access requests are processed in parallel without interfering with each other.

Then, the request processing unit 211 issues the access requests for invalidating the data associated with the address A with respect to also the second core, the third core and the fourth core in the same way as in the case of the first core (S5005).

Further, with respect to the access requests about the L1 REPLACE that are given respectively from the second core and the fourth core, the L2 cache 200 updates the L1 tag copies in the same way as in the case of the first core when issuing the access requests to the respective cores. Therefore, the L2 cache control unit 210 of the L2 cache 200 updates the L1 tag copies of the second core and the fourth core (S5006). This update process is described in the same manner as the process in S5003 is.

Note that with respect to the access request about the L1 REPLACE that is given from the third core, the L2 cache 200, after issuing the access request for the third core, updates the L1 tag copy when the completion response to the order related to the access request is sent back from the third core. Accordingly, the L1 tag copy of the third core is not updated at this point of time.

Next, upon completing the invalidating process in each core, the L2 cache 200 receives notification (completion response) indicating that the invalidating process has been completed from each core. FIGS. 14D and 14E illustrate operations of the L2 cache 200 at this time. More specifically, FIG. 14D illustrates the operation of the L2 cache 200 in such a case that the completion response coming from the first core reaches the L2 cache 200, while the completion responses from other cores exclusive of the first core do not yet reach the L2 cache 200. Moreover, FIG. 14E illustrates the operation of the L2 cache 200 in a case where the completion response coming from the third core reaches the L2 cache 200, while the completion responses from the fourth core does not yet reach the L2 cache 200.

When the L2 cache 200 receives the completion response from the first core (S5007), in accordance with this completion response, the address lock control unit 212 cancels the lock set based on the order corresponding to the completion response (S5008).

Further, the final response detecting unit 213 determines whether the completion response given from the first core is the final completion response or not. At this point of time, there exist not-yet-reached completion responses from other cores excluding the first core, and the relevant completion response is not therefore the final completion response. For this reason, the final response detecting unit 213 determines the completion response given from the first core not to be the final completion response.

Herein, since the plurality of processes is executed for the address A in parallel, the L1 shared information 502 associated with the address A may be, even if not updated corresponding to each process, updated after completing the plurality of processes. Therefore, in the present embodiment, the update of the L1 shared information 502 is carried out corresponding to the final completion response. Hence, the update of the L1 shared information 502 is not carried out corresponding to the completion response given from the first core.

Note that the L2 cache 200 executes, for the completion response given from the second core, also the same process as the process for the completion response given from the first core. A status depicted in FIG. 14E exemplifies a status of receiving the completion response from the third core after the L2 cache 200 has executed the processes for the completion responses given from the first core and the second core.

As illustrated in FIG. 14E, the L2 cache 200, upon receiving the completion response from the third core (S5009), the address lock control unit 212 cancels, in accordance with the completion response, the lock set based on the order corresponding to the completion response (S5010).

Moreover, the update process of the L1 tag copy about the access request for the third core is executed when the completion response to the order related to the access request is sent back from the third core. Therefore, the L2 cache control unit 210 starts executing the update process of the L1 tag copy of t the third core (S5011).

Note that on the occasion of these processes, in the same way as the process for the completion response given from the first core, the final response detecting unit 213 determines whether the completion response given from the third core is the final completion response or not. At this point of time, the completion response given from the fourth core is not yet reached, and hence the completion response given from the third core is not the final completion response. Therefore, in the same manner as the process for the completion response given from the first core, the final response detecting unit 213 determines the completion response given from the third core not to be the final completion response. Further, in the same way as the process for the completion response given from the first core, the update of the L1 shared information 502 is not carried out corresponding to the completion response given from the third core.

Finally, the L2 cache 200 receives the completion response from the fourth core as the final completion response. FIG. 14F depicts the operation of the L2 cache 200 on the occasion of receiving the completion response from the fourth core.

When the L2 cache 200 receives the completion response from the fourth core (S5012), the address lock control unit 212 cancels, in accordance with the completion response, the lock set based on the order corresponding to the completion response (S5013).

Moreover, the final response detecting unit 213 of the L2 cache control unit 210 determines whether the completion response given from the fourth core is the final completion response or not. As illustrated in FIG. 14F, the completion response given from the fourth core is the final completion response about the order targeted at the address A. Hence, the final response detecting unit 213 determines that the completion response given from the fourth core is the final completion response.

The L2 cache control unit 210 inputs, corresponding to the determination made above, the request for the update process of the L1 shared information 502 associated with the address A onto the pipeline. At this time, the retry control unit 214 determines whether or not the update process of the L1 tag copy 223 associated with the address A, which precedes the update process of the L1 shared information 502, exists on the pipeline.

The retry control unit 214, when determining the preceding update process of the L1 tag copy 223 exists on the pipeline, cancels the update process of the L1 shared information 502 and then gets the update process to be retried. For example, if the update process of the L1 tag copy of the third core in S5011 is executed underway, the retry control unit 214 cancels the update process of the L1 shared information 502 and then gets the update process to be retried. Whereas if the retry control unit 214 determines that the preceding update process of the L1 tag copy 223 does not exist on the pipeline, the L1 tag copy 223 is referred to, and the update process of the L1 shared information 502 is executed (S5014).

The L2 cache 200 according to the present embodiment thus operates. Note that the respective processes may be properly conducted in parallel, and a processing sequence may be replaced. For instance, the process in S5001 and the process in S5002 may be conducted in parallel and may also be replaced in processing sequence.

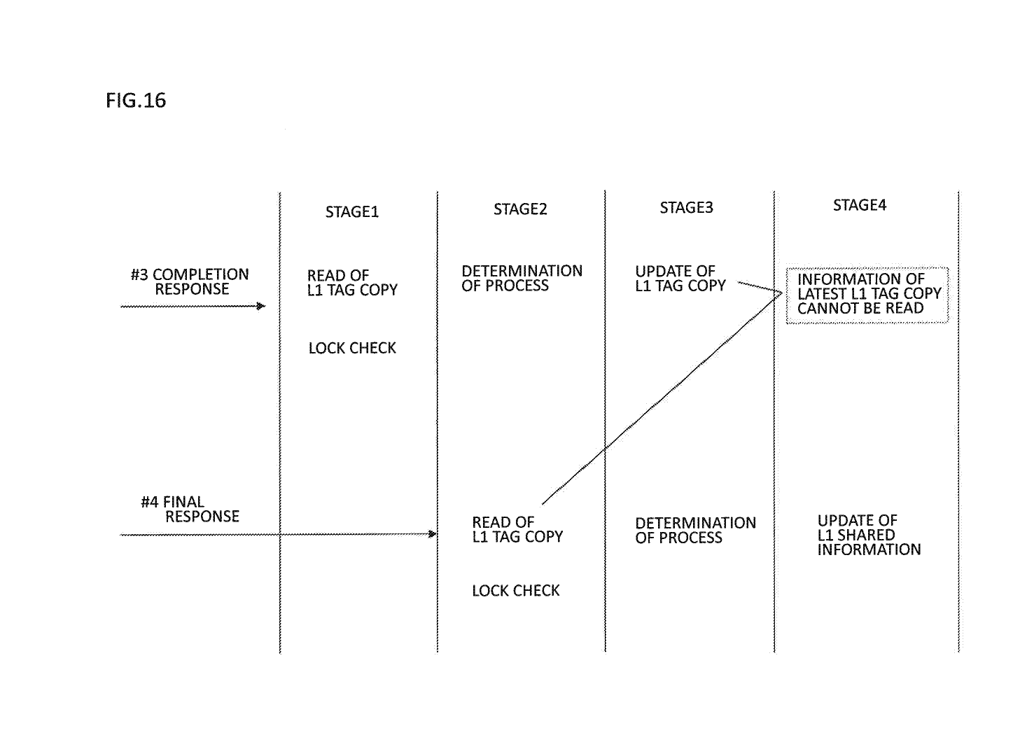

The operations being performed as illustrated in FIGS. 14A-14F, the L2 cache 200 according to the present embodiment obviates a problem that may occur in the case of the process of such a type as to update the L1 tag copy 223 when making the order response. This problem is elucidated by use of FIGS. 15 and 16.

FIG. 15 depicts a case in which the L1 REPLACE occurs in the way of being targeted at the lines of L1 caches caching the data associated with the address A in each of the first core through the fourth core. Note that in the example depicted in FIG. 15, in the same way as in the examples illustrated in FIGS. 14A-14F, with respect to the third core, the L1 tag copy 223 related to the third core is updated corresponding to the completion response given from the third core. Further, as for the first core, the second core and the fourth core, the L1 tag copies 223 related to the respective cores are updated when issuing the access requests for these cores.

In the example illustrated in FIG. 15, the data associated with the address A are replaced based on the L1 REPLACE by the data associated with the addresses B, C, D and E in the respective cores. Herein, a symbol “L1-RPL(A)#1” in FIG. 15 represents timing when the L2 cache 200 issues the access request about the L1 REPLACE to the first core. Further, a symbol “#1 response” represents timing when the L2 cache 200 receives the completion response with respect to the order related to the access request about the L1 REPLACE from the first core.

In this example, the update of the L1 tag copy 223 associated with the third core and the update of the L1 shared information 502 associated with the address A are executed at the same timing. In this case, such a possibility exists that the reference to the L1 tag copy 223 for updating the L1 shared information 502 associated with the address A occurs before completing the update of the L1 tag copy 223 associated with the third core. In other words, in the examples illustrated in FIGS. 14A-14F, there exists the possibility of executing the reference to the L1 tag copy 223 in the update process of the L1 shared information 502 in S5014 before completing the update process of the L1 tag copy of the third core in S5011.

FIG. 16 illustrates the operation in a case where the reference to the L1 tag copy 223 for updating the L1 shared information 502 associated with the address A occurs before completing the update of the L1 tag copy 223 associated with the third core.

In the example depicted in FIG. 16, a data write to the entry of the L1 tag copy 223 associated with the third core in the update process of the L1 tag copy 223 associated with the third core is executed in a stage 3. By contrast with this, the reference to the L1 tag copy 223 for updating the L1 shared information 502 is executed in a stage 2. Therefore, a latest status of the third core is not reflected in the update of the L1 shared information 502. Moreover, both of the update process of the L1 tag copy 223 about the third core and the update process of the L1 shared information 502 are the processes associated with the address A. Hence, the latest status of the third core is not reflected, resulting in a possibility that the L1 shared information 502 is to be updated with the information indicating an erroneous status. This type of problem may arise if there exists the process of such a type as to update the L1 tag copy 223 when making the order response.

Note that this problem does not arise when the respective processes individually occurring at the same timing with respect to the same address are executed on a one-by-one basis. The reason why so is that the respective processes are executed on the one-by-one basis, and hence such a status does not come out that the processes illustrated in FIG. 16 are executed in parallel. Namely, in the present embodiment, the plurality of processes individually occurring at the same timing with respect to the same address is conducted in parallel, and consequently the problem described as such may arise. However, the L2 cache 200 according to the present embodiment solves this problem through the operation of the retry control unit 214.

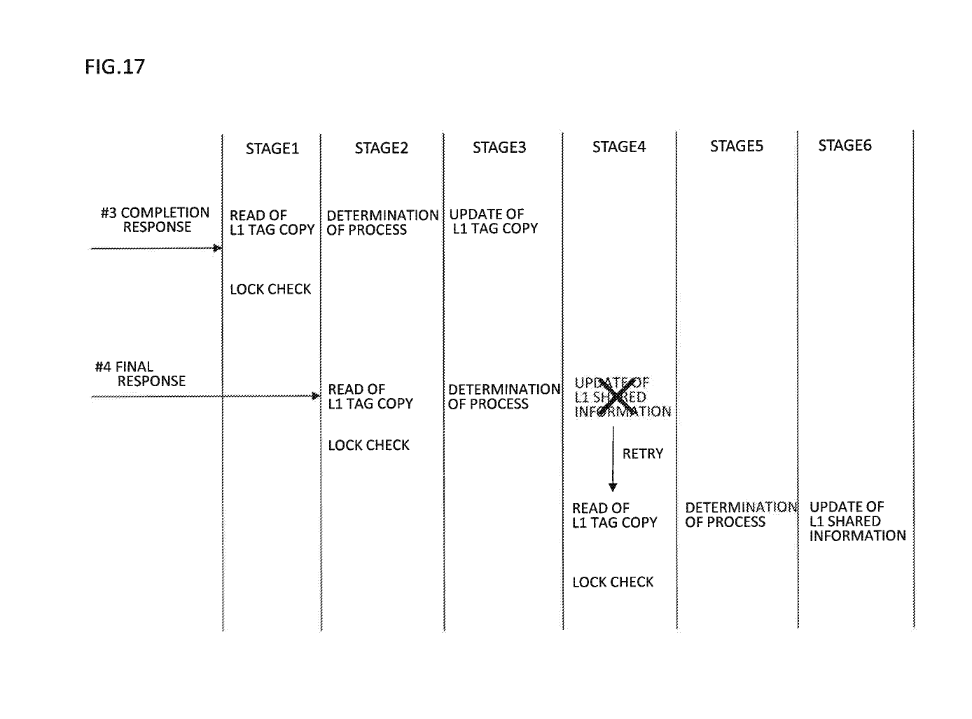

FIG. 17 illustrates the operation of the L2 cache 200 according to the present embodiment. In the present embodiment, similarly to FIG. 16, the reference to the L1 tag copy 223 is executed at the stage 2, and the update process (overwrite process) of the L1 tag copy is carried out at the stage 3.

Herein, unlike the example in FIG. 16, in the present embodiment, the retry control unit 214 cancels the update process (overwrite process) of the L1 shared information 502, which is to be executed at a stage 4. This is because the update process of the L1 tag copy 223 related to the third core exists on the pipeline, in which case the retry control unit 214 cancels the update process of the L1 shared information 502 and gets the update process to be retried.

Through this operation of the retry control unit 214, in the present embodiment, the reference to the L1 tag copy 223 for the L1 shared information 502 is executed again at the stage 4. Then, at this point of time, the update process of the L1 tag copy 223 is completed. Therefore, the present embodiment solves the problem as illustrated in FIG. 16.

§4 Example of Circuit

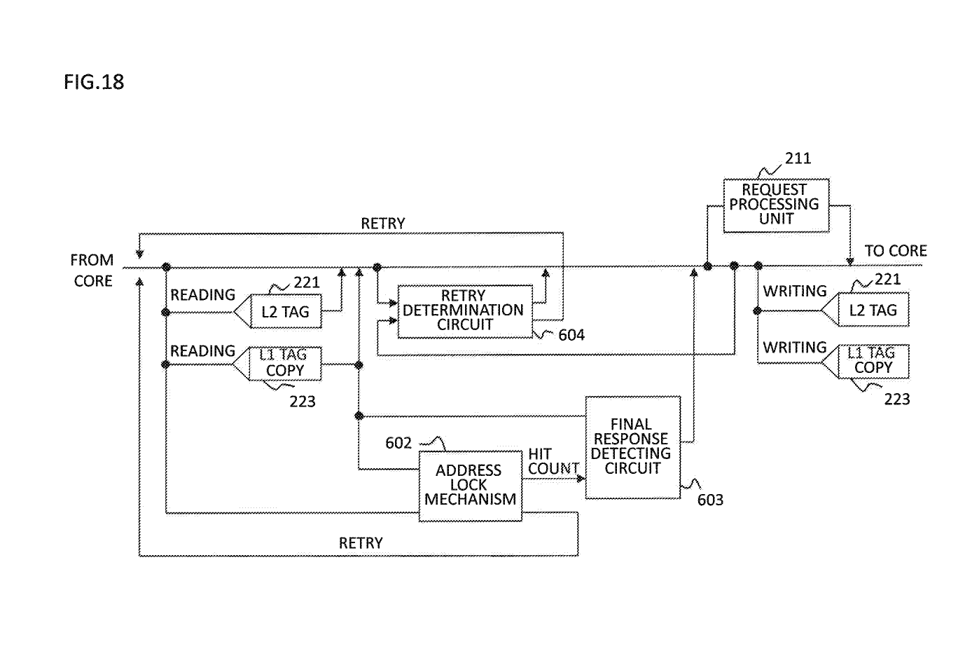

Next, examples of circuits according to the present embodiment are illustrated in FIGS. 18-25. FIG. 18 depicts circuits of the L2 cache control unit 210 according to the present embodiment. As depicted in FIG. 18, the L2 cache control unit 210 according to the present embodiment includes a request processing unit 211, an address lock mechanism 602, a final response detecting circuit 603 and a retry determination circuit 604. Note that the address lock mechanism 602 corresponds to the address lock control unit 212. The final response detection circuit 603 corresponds to the final response detecting unit 213. The retry determination circuit 604 corresponds to the retry control unit 214. In-depth descriptions of the respective circuits will be given later on.

Note that the final response detecting circuit 603 according to the present embodiment determines, based on the use of hit information of the address lock mechanism, whether the target completion response is the final completion response or not. The final response detecting circuit 603 may, however, be any type of circuit if capable of determining whether the target completion response is the final completion response or not. For instance, the final response detecting circuit 603 may be realized by a counter. In this case, the number of orders for the same address, which are issued at the same timing to the cores, is set in the counter of the final response detecting circuit 603. Then, each time the completion response is received, a counter value is decremented by “1”. At this time, the final response detecting circuit 603 determines that the completion response given when the counter value becomes “0” is the final completion response, and determines that the completion responses other than this response are not the final completion responses.

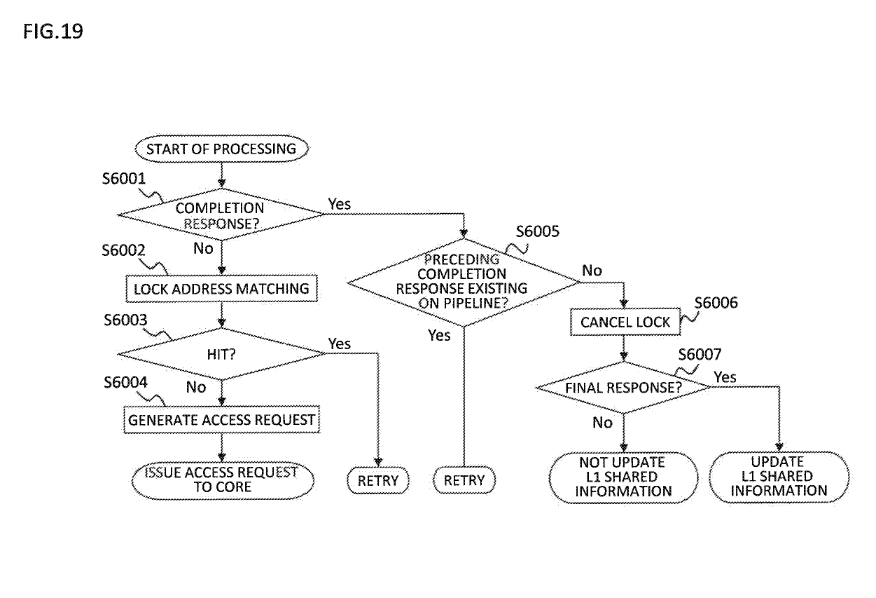

FIG. 19 illustrates an operational example of the L2 cache control unit 210 according to the present embodiment. In the operational example illustrated in FIG. 19, the processing starts from when the data coming from the cores are inputted onto the pipelines of the L2 cache 200 and fetched by the L2 cache control unit 210.

In S6001, the L2 cache control unit 210 determines whether the processing target data given from the core is the data indicating the completion response or not. If the processing target data is not the data indicating the completion response (No in S6001), the process advances to next step S6002. Whereas if the processing target data is the data indicating the completion response (Yes in S6001), the process diverts to subsequent step S6005.

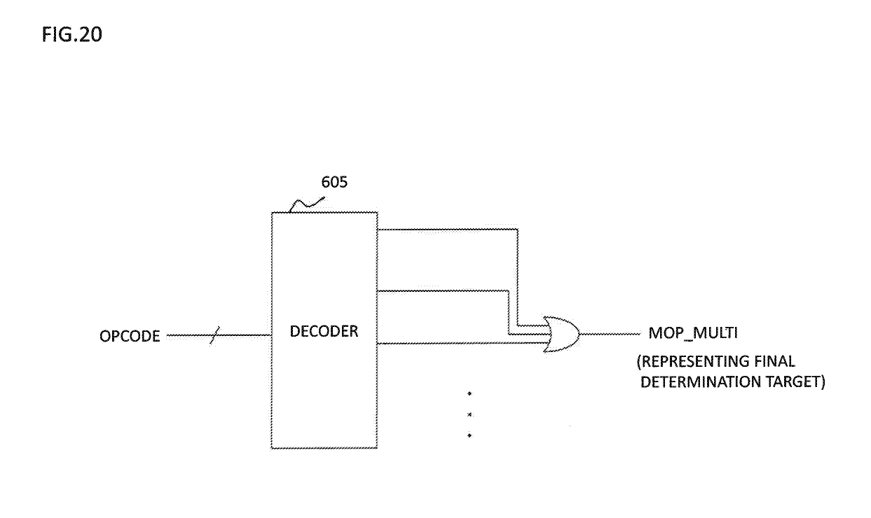

FIG. 20 illustrates a circuit for determining whether the processing target data is the data indicating the completion response or not. In the present embodiment, the L2 cache control unit 210 makes the determination on the basis of an output at a decode stage on the pipeline. If an opcode (operation code) of the data existing at the decode stage of the pipeline indicates the completion response, this data is the target data for determining whether to be the final completion response or not. This step is a process for distinguishing whether or not the processing target data is targeted at the determination described as such.

Note that in the following discussion, a target for determining whether to be the final completion response or not will be termed a “final determination target”. A circuit depicted in FIG. 20 determines, based on an output of a decoder 605, whether the data existing at the decode stage of the pipeline is the data becoming the final determination target or not. Namely, in the present embodiment, setting of the decoder 605 may be changed so that the data other than the data indicating the completion response become the final determination targets. In this case, it is determined in S6001 whether the processing target data given from the core is the final determination target or not.

Furthermore, a value of “MOP_MULTI” in FIG. 20 becomes “1” if the processing target data given from the core is the final determination target data such as the data indicating the completion response. In other cases excluding this instance, the value of “MOP_MULTI” becomes “0”.

Referring back to FIG. 19, whereas if the processing target data is not the data indicating the completion response (“No” in S6001), next step S6002 is executed. In S6002, in the address lock mechanism 602, the cache block becoming the access request target is checked against the lock target cache block. This process corresponds to a lock check process of determining whether the cache block becoming the access request target is locked or not.

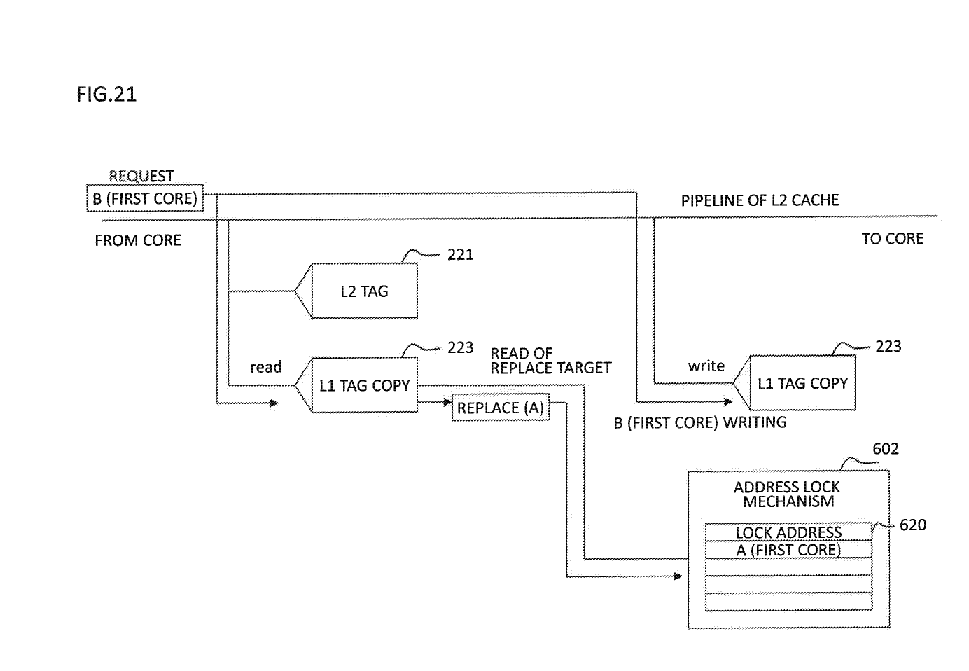

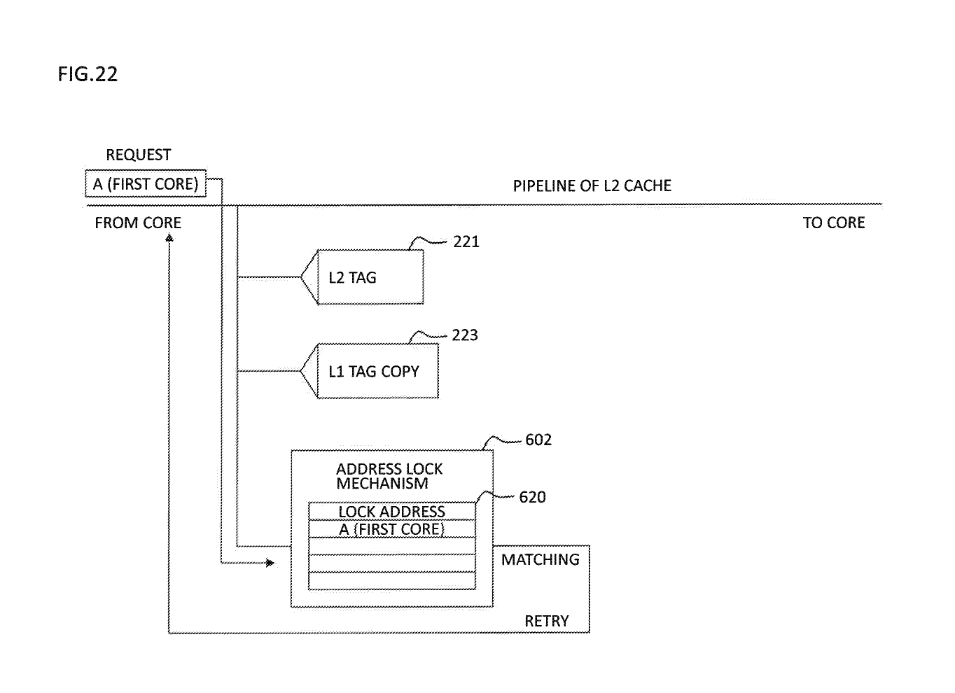

The lock check to be made by the address lock mechanism 602 is described by use of FIGS. 21 and 22. FIG. 21 illustrates an operation in which the address lock mechanism 602 locks an L1 REPLACE target address. As illustrated in FIG. 21, the address lock mechanism 602 includes a retaining unit 620 for retaining the data indicating the lock target.

In the example depicted in FIG. 21, the L2 cache control unit 210 receives, from the first core, the access request containing a REPLACE request address B. The L2 cache control unit 210 reads the data stored in the entry of the L1 tag copy 223 associated with the line related to the REPLACE target of the first core on the basis of the data contained in the access request. It is to be noted that the data to be read is the data corresponding to the REPLACE target address.

The address lock mechanism 602 registers, in the retaining unit 620, information indicating the cache block specified by a REPLACE target address A specifiable from the readout data and by the first core as the information indicating the lock target cache block. Note that after executing the read of the REPLACE target data, the L2 cache control unit 210 overwrites the data related to the REPLACE request address B to the readout entry. The L1 tag copy 223 is thereby updated.

FIG. 22 illustrates an operation in which the address lock mechanism 602 retries the request for the address kept locking. As depicted in FIG. 22, the address lock mechanism 602 checks the cache block as the target block of the request given from the core against the lock target cache block retained by the retaining unit 620, thereby determining whether the cache block as the target block of the request given from the core is locked or not.

If information coincident with or corresponding to the information indicating the cache block as the target block of the request given from the core is registered in the retaining unit 620 by way of the information indicating the lock target cache block, the address lock mechanism 602 determines that the request target cache block is locked. Then, the address lock mechanism 602 cancels the execution the process related to the request and re-inputs this request onto the pipeline, thereby getting the execution of the request-related process to be retried.

Thus, the address lock mechanism 602 makes a lock check of the cache block as the target block of the request given from the core. Note that the retaining unit 620 depicted in FIGS. 21 and 22 retains the address information indicating the target address of the request related to the lock and the core number for identifying the core having issued the request related to this lock. As described above, other items of information exclusive of these items of information may also be registered in the retaining unit 620.

Referring back to FIG. 19, when the cache block becoming the access request target is checked against the lock target cache block, subsequently it is determined in S6003 of the check process whether the cache block becoming the access request target is hit or not. If hit, since the cache block becoming the access request target is locked, the access request is retried through the operation of the address lock mechanism 602 illustrated in FIG. 22. Whereas if not hit, the cache block becoming the access request target is not locked, and hence the process advances to next step S6004.

In S6004, the request processing unit 211 executes the process related to the access request given from the core. Then, the request processing unit 211 issues the access request based on the executed process to the core. The access request to be issued is, e.g., a request for an invalidating process of the data associated with the address A.

While on the other hand, if the processing target data is the data indicating the completion response (“Yes” in S6001), the processing target data is the data indicating the completion response. At this time, in next step S6005, the retry determination circuit 604 determines whether or not the preceding completion response targeted at the same address as the address of the processing target completion response exists on the pipeline.

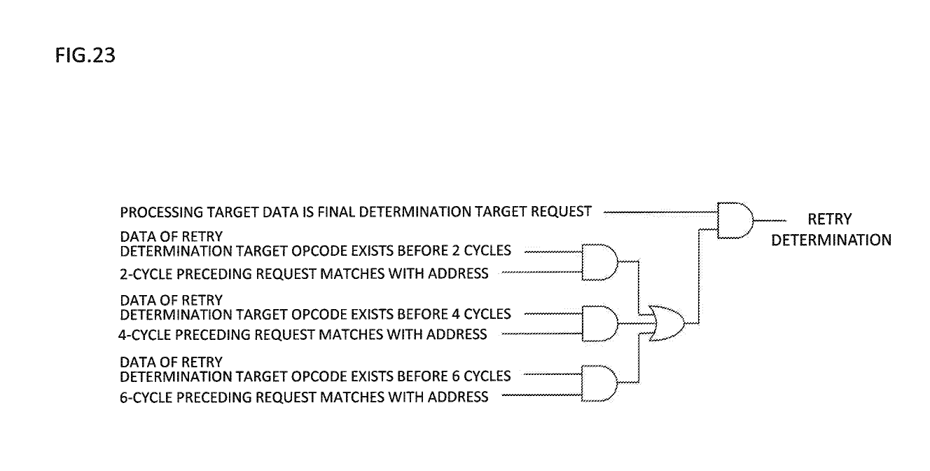

FIG. 23 illustrates a logical circuit of the retry determination circuit 604 according to the present embodiment. The retry determination circuit 604 according to the present embodiment, if an output of the logical circuit illustrated in FIG. 23 becomes “1”, determines that the preceding completion response exists thereon (“Yes” in S6005).

To be specific, the processing target data is the final determination target data, and the request existing at the preceding stage on the pipeline contains a retry control target opcode and is targeted at the same address as the address of the processing target data, in which case the output of the retry determination circuit 604 becomes “1”.

Note that the “retry control target opcode” connotes an opcode becoming a retry determination target of the retry determination circuit 604. Such an opcode may be arbitrarily set. The retry control target opcode according to the present embodiment contains an opcode specifying the completion response. Furthermore, the retry control target opcode may also contain an opcode specifying the final completion response as a substitute for the opcode specifying the completion response.

Herein, the pipeline according to the present embodiment is provided with such a restriction that the plurality of requests targeted at the same address is not disposed at the adjacent stages. Therefore, a stage for every 2 cycles is given as the preceding stage on the pipelines in the logical circuit depicted in FIG. 23.

Moreover, the retry determination circuit 604 according to the present embodiment sets the stages before six cycles as the retry control target stages. The stages becoming the retry control target stages can be changed due to factors such as the number of stages of the pipelines and positions of the stages at which to implement the orders. Hence, the stages becoming the retry control target stages are properly selected based on these factors. In the present embodiment, the stages before the six cycles are set as the retry control target stages.

The thus-configured retry determination circuit 604 determines whether the preceding completion response targeted at the same address as the address of the processing target completion response exists on the pipeline or not.

If the preceding completion response exists (“Yes” in S6005), the retry determination circuit 604 cancels the order issued based on the processing target completion response. Then, the retry determination circuit 604 re-inputs the data indicating the completion response onto the pipeline, and retries the process of the order issued based on the completion response.

Whereas if the preceding completion response does not exist (“No” in S6005), the process advances to next step S6006.

In S6006, the lock, which is set based on the access request corresponding to the processing target completion response, is canceled. Specifically, the address lock mechanism 602 invalidates the data associated with the lock target cache block coincident with the target cache block of the completion response given from the core in the retaining unit 620. The data invalidation may be realized by deleting the data retained by the retaining unit 620 and may also be realized by permitting the data to be overwritten to a field for storing the data. The data invalidation may be realized by whatever methods. The lock related to the access request with its processing being completed is thereby canceled.

Finally, in S6007, the final response detecting circuit 603 determines whether the processing target completion response is the final completion response or not. If the processing target completion response is not the final completion response (“No” in S6007), none of the processes related to the update of the L1 shared information are executed. Whereas if the processing target completion response is the final completion response (“Yes” in S6007), the processes related to the update of the L1 shared information are executed.

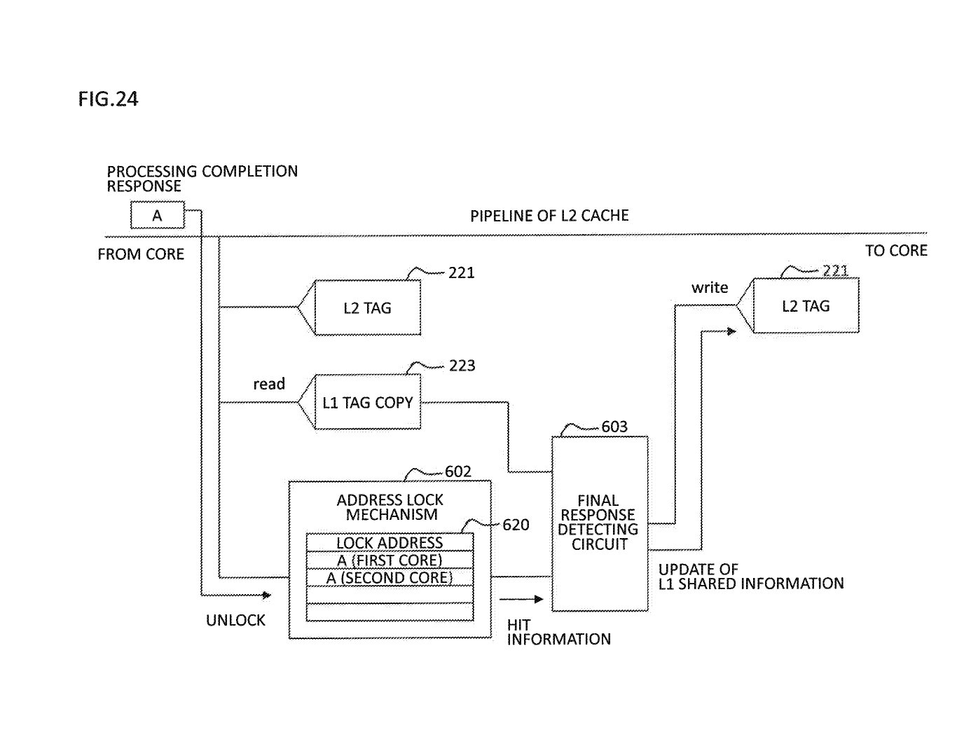

FIG. 24 illustrates an operation of the final response detecting circuit 603. As illustrated in FIG. 24, the final response detecting circuit 603 according to the present embodiment determines, based on the use of the hit information of the address lock mechanism 602, whether or not the processing target completion response is the final completion response, thereby detecting the final completion response. Note that the hit information indicates an issuer of the access request, which is coincident with the address associated with the completion response. In the example depicted in FIG. 24, the hit information indicates “A (the first core)” and “A (the second core)”.

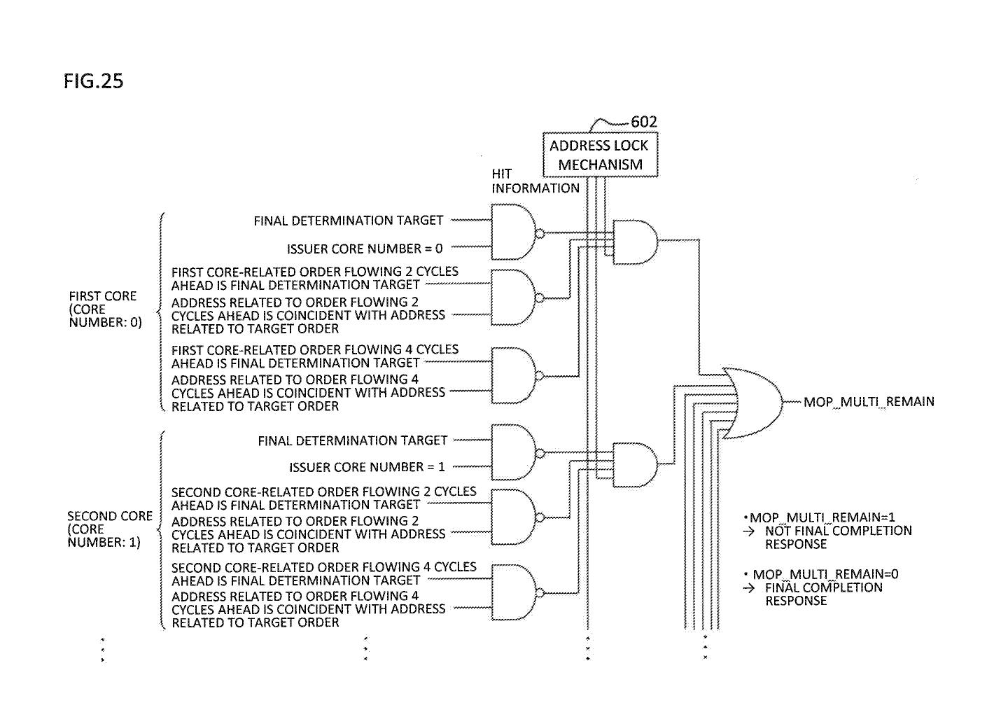

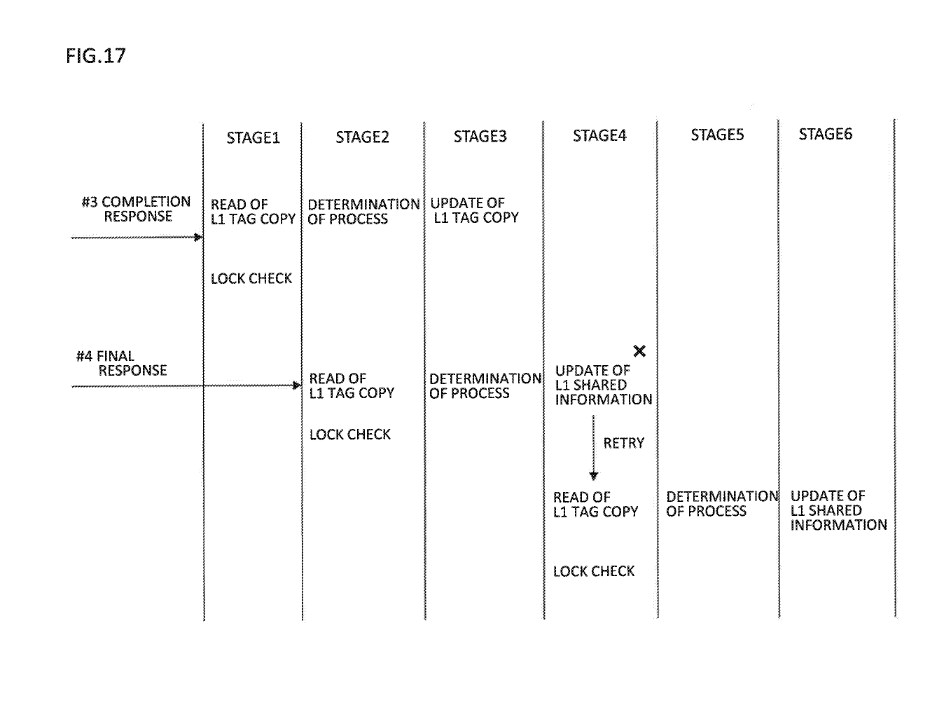

FIG. 25 illustrates a logical circuit of the final response detecting circuit 603. Incidentally, a value of an output “MOP_MULTI_REMAIN” of the final response detecting circuit 603 illustrated in FIG. 25 becomes “0” if the processing target completion response is the final completion response. Whereas if the processing target completion response is not the final completion response, the value of “MOP_MULTI_REMAIN” becomes “1”.

The final response detecting circuit 603 illustrated in FIG. 25 includes three NAND gates per core as a first stage. Then, the final response detecting circuit 603 includes an AND gate for taking a logical product of outputs of the three NAND gates and a per-core output (hit information) of the address lock mechanism 602 with respect to each core as a second stage. Further, the final response detecting circuit 603 includes, as a third stage, an OR gate for taking a logical sum of the AND gates provided at the second stage for the respective cores.

As illustrated in FIG. 25, when the output of the AND gate at the second stage for any one of the cores becomes “1”, the processing target completion response is determined not to be the final completion response. The outputs of the three NAND gates at the first stage and the output of the address lock mechanism 602 for each core, are inputted to the AND gate at the second stage.

The output of the address lock mechanism 602 becomes “1” for the cores registered as the issuers of the access requests each coincident with the address associated with the processing target completion response. For example, in the status illustrated in FIG. 24, with respect to the address A associated with the processing target completion response, the output of the hit information for the first core and the output of the hit information for the second core become “1”.

Inputted herein to the first NAND gate are a value indicating whether the processing target is the final determination target or not and a value indicating whether the core having issued the processing target completion response is the self-core or not. Accordingly, if the processing target completion response is the completion response issued from the self-core, the output of the first NAND gate becomes “0”.

Such a situation is considered that, e.g., the completion response issued by the first core is the processing target completion response. Further, it is assumed that the address lock mechanism 602 is registered with the first core as the issuer of the access request targeted at the address associated with the processing target completion response but is not registered with the cores other than the first core. Namely, the assumption is that the address lock mechanism 602 is registered with items of information indicating the address associated with the processing target completion response and indicating the first core but is not registered with items of information indicating the address associated with the processing target completion response and indicating the cores other than the first core.

In this case, the processing target is the completion response, the core having issued the completion response is the first core, and hence the output of the first NAND gate corresponding to the first core becomes “0”. Further, the address lock mechanism 602 is registered with none of the information indicating the address associated with the processing target completion response and indicating the cores other than the first core, and therefore the outputs of the address lock mechanism 602 related to other cores excluding the first core are “0”. Hence, in this case, the processing target completion response is determined to be the final completion response.

That is, this first NAND gate is a gate for eliminating the lock related to the core having issued the processing target completion response from the determination as to whether the completion response is the final completion response or not. If the completion response given from the core is the final completion response, typically, the core having issued the completion response is locked, while other cores are not locked. The first NAND gate is the gate configured to correspond to this status.

Moreover, the second and third NAND gates are gates configured for the preceding orders respectively. The second NAND gate and the third NAND gate are the same except that the positions of the target pipelines are different.

Inputted to these NAND gates are a value indicating whether or not the request existing at the preceding stage on the pipeline is the final completion response and a value indicating whether or not the request target address is coincident with the address associated with the processing target completion response. Namely, the outputs of the second and third NAND gates become “0” if the completion response associate with the same address as the address of the processing target completion response exists at the preceding stage on the pipeline.

For example, the status in which the outputs of these NAND gates are “0” and the output of the address lock mechanism 602 is “1”, implies a status in which the update of the lock cancelation is not processed and the completion response about the lock cancelation exists at the preceding stage on the pipeline. That is, the second and third NAND gates are the gates configured to reflect the not-yet-updated lock cancelation in the determination as to whether the processing target completion response is the final completion response or not.

The address lock mechanism 602 detects the final completion response through these gates. To be specific, the address lock mechanism 602 outputs “0” if the processing target completion response is the final completion response but outputs “1” whereas if not.

Note that in the final response detecting circuit 603 illustrated in FIG. 25, the stage per 2 cycles is exemplified as the preceding state on the pipeline for the same reason as in the retry determination circuit 604. Furthermore, for the same reason as in the retry determination circuit 604, the stage serving as the final response detection target can be changed. In the present embodiment, the stages up to 4 cycles before become the final response detection targets.

Note that the final response detecting circuit 603 may be realized anywise if capable of detecting that the target completion response is the final completion response. For example, the final response detecting circuit 603 may, if the number (hit count) of cache blocks being hit in the address lock mechanism 602 is “1”, determine that the processing target completion response is the final completion response. In this case, the preceding completion response with the unexecuted lock cancelation may exist on the pipeline, depending on a step count of the pipeline. For precisely determining the final completion response, the final response detecting circuit 603 may be provided with a circuit for detecting such a status. For instance, the NAND gate related to the preceding completion response (order) depicted in FIG. 24 can detect this status as described above.

The final response detecting circuit 603 described as such determines whether the processing target completion response is the final completion response or not. Then, if the processing target completion response is the final completion response, the process about the update of the L1 shared information is executed.

Note that on the occasion of issuing the access request related to the update of the L1 shared information, as described above, the retry control unit 214 implements the retry determination about the update process of the L1 shared information. In this operational example, the retry determination is attained in S6005. The retry determination circuit 604 corresponding to the retry control unit 214 implements, as described above, in S6005, the retry determination for the processing target completion response without being limited to the determination as to whether the processing target completion response is the final completion response or not. The completion response as this retry determination target contains the final completion response. Therefore, the operation of the retry control unit 214 is realized through the operation of the retry determination circuit 604.

On the other hand, the retry determination circuit 604 may implement the retry determination by distinguishing whether the processing target completion response is the final completion response by use of a detection result of the final response detecting circuit 603. For example, the process in S6005 may be executed subsequent to an arrow line of “Yes” in S6007. In this instance, the final completion response is retried, whereby the order related to the update of the L1 shared information is retried as the case may be. At this time, the lock set based on the access request corresponding to the completion response is canceled, and hence the address lock mechanism 602 registers again the canceled lock.

§5 Operations and Effects of Present Embodiment

Finally, operations and effects of the present embodiment will be described.

In the present embodiment, the address lock control unit 212 identifies the core and locks the access requester related to the lock, and the final response detecting unit 213 and the retry control unit 214 adequately control the access requests. These operations being thus done, in the present embodiment, the processing responses occurring individually at the same timing can be processed in parallel. Therefore, according to the present embodiment, the processing responses occurring individually at the same timing in the respective cores can be processed in parallel, thereby enabling an improvement of the deteriorated latency, which is consequent upon the increase in number of the cores.

Note that as the core count gets larger, there are more of opportunities enabling the parallel processing to be done. Consequently, with the rise in number of the cores, an effect of improvement of performance owing to the present embodiment augments.

Furthermore, in the present embodiment, the retry determination circuit 604 accomplishes the retry determination by referring to the preceding access request on the pipeline. Therefore, according to the present embodiment, it is feasible to obviate a gate delay problem of the retry determination circuit (FIG. 6), which is consequent upon the increase in number of the cores.

Moreover, in the present embodiment, the address lock control unit 212 identifies the core and locks the access requester related to the lock. Consequently, the subsequent process, which is followed by the retry process related to the conventional “read modify write” process, becomes limitative.

Further, in the present embodiment, the retry determination circuit 604 can implement the retry determination without referring to L1 tag copy 223. Therefore, the same processes as the conventional processes can be done without using the hit information of the L1 tag copy 223, and the latency is improved.

According to one mode, it is feasible to improve the deteriorated latency being consequent upon the increase in core count.

### DESCRIPTION OF THE REFERENCE NUMERALS AND SYMBOLS

100, 110, 1m0 processor core
101, 111, 1m1 instruction control unit
102, 112, 1m2 arithmetic execution unit
103,113, 1m3 L1 cache
104 L1 cache control unit
104a address translation unit
104b request processing unit
105 L1 instruction cache
105a L1 tag
105b L1 data
105 L1 operand cache
106a L1 tag
106b L1 data
200 L2 cache
210 L2 cache control unit
211 request processing unit
212 address lock control unit
213 final response detecting unit
214 retry control unit
220 L2 cache data unit
221 L2 tag
222 L2 data
223 L1 tag copy
602 address lock mechanism
603 final response detecting circuit
604 retry determination circuit
605 decoder
620 retaining unit

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An arithmetic processing apparatus comprising:
a plurality of arithmetic processing units configured to respectively perform arithmetic operations and to output access requests;
a cache memory to retain data undergoing the arithmetic processes of the plurality of arithmetic processing units in cache blocks;
a retaining unit configured to retain a control target address specifying a control target cache block and control target identifying information specifying an arithmetic processing unit of a control target access requester; and
a control unit configured to control an access request for the cache block specified by the control target address and the control target identifying information on the basis of an access target address contained in an access request issued by any one of the plurality of arithmetic processing units and requester identifying information specifying the arithmetic processing unit having issued the access request.

2. The arithmetic processing apparatus according to claim 1, wherein the control unit further includes a detecting unit configured to detect a final completion response completed finally in completion responses corresponding to a plurality of access requests issued to the same cache block by the plurality of arithmetic processing units, and
cancels, when an access request for the same address as an address contained in the access request issued corresponding to the final completion response is issued from any one of the plurality of arithmetic processing units, executing the access request issued corresponding to the final completion response.

3. The arithmetic processing apparatus according to claim 2, wherein the control unit, after cancelling executing the access request issued corresponding to the final completion response, re-issues the cancelled access request.

4. A control method of an arithmetic processing apparatus including a plurality of arithmetic processing units, a cache memory, a retaining unit, and a control unit, the control method comprising:
performing arithmetic operations to output access requests respectively with the plurality of arithmetic processing units;
retaining data undergoing the arithmetic processes of the plurality of arithmetic processing units in cache blocks of the cache memory;
retaining a control target address specifying a control target cache block and control target identifying information specifying an arithmetic processing unit of a control target access requester with the retaining unit; and
controlling an access request for the cache block specified by the control target address and the control target identifying information on the basis of an access target address contained in an access request issued by any one of the plurality of arithmetic processing units and requester identifying information specifying the arithmetic processing unit having issued the access request with the control unit.

5. The control method of the arithmetic processing apparatus according to claim 4, wherein the control unit further detects a final completion response completed finally in completion responses corresponding to the plurality of access requests issued to the same cache block by the plurality of arithmetic units, and
the control unit, when an access request for the same address as an address contained in the access request issued corresponding to the final completion response is issued from any one of the plurality of arithmetic processing units, cancels executing the access request issued corresponding to the final completion response.

6. The control method of the arithmetic processing apparatus according to claim 5, wherein the control unit further, after cancelling executing the access request issued corresponding to the final completion response, re-issues the cancelled access request.
